(19) United States
(12) Patent Application Publication
(10) Pub. No.: US 2025/0316012 A1
(43) Pub. Date: Oct. 9, 2025

(54) MODEL PROCESSING METHOD, APPARATUS, AND DEVICE, STORAGE MEDIUM, AND COMPUTER PROGRAM PRODUCT

(71) Applicant: Tencent Technology (Shenzhen) Company Limited, Shenzhen (CN)

(72) Inventor: Guowen CHEN, Shenzhen (CN)

(73) Assignee: Tencent Technology (Shenzhen) Company Limited, Shenzhen (CN)

(21) Appl. No.: 19/244,364

(22) Filed: Jun. 20, 2025

Related U.S. Application Data
(63) Continuation of application No. PCT/CN2024/095807, filed on May 28, 2024.

(30) Foreign Application Priority Data
Jun. 30, 2023 (CN) 202310803347.9

(51) Int. Cl. G06T 13/40; G06T 19/20

(52) U.S. Cl. CPC G06T 13/40; G06T 19/20; G06T 2219/2021

(57) ABSTRACT

A model processing method includes, obtaining a first source head model and a plurality of pieces of expression feature data; performing deformation matching on the first source head model according to a first model feature of a target head model, to obtain a second source head model; determining a deformation parameter according to a first deformation relationship between the first and second source head models and a second deformation relationship from a first model expression to a second model expression, the first model expression being determined according to neutral feature data of the first source head model, and the second model expression being determined according to expression feature data indicated by an expression movement instruction in the plurality of pieces of expression feature data; and performing expression transfer on the target head model according to the deformation parameter, to obtain a target head model having the second model expression.

### CROSS-REFERENCE TO RELATED APPLICATIONS

This application is a continuation application of International Application No. PCT/CN2024/095807 filed on May 28, 2024, which claims priority to Chinese Patent Application No. 202310803347.9 filed with the China National Intellectual Property Administration on Jun. 30, 2023, the disclosures of each being incorporated by reference herein in their entireties.

### FIELD

The disclosure relates to the field of artificial intelligence, and in particular, to a model processing method, apparatus, and device, a storage medium, and a computer program product.

### BACKGROUND

At present, three-dimensional (3D) animation is widely used in various industries, such as Computer Graphics (CG) films, 3D animated films, virtual live streaming, and virtual 3D customer service agents. The content production of 3D expression animation is a critical bottleneck in the industry development. A blend shape (BS) may be generated through manual face sculpting, and a model expression is further constructed based on the generated blend shape. Different three-dimensional head models may have different facial features, such as different face contours, different shapes of facial organs, and different distributions of facial organs. When model expressions may be constructed for different three-dimensional head models, the reliance on manual face sculpting, results in low automation and excessive consumption of human resources.

### SUMMARY

Embodiments of this application provide a model processing method, apparatus, and device, a storage medium, and a computer program product, for transferring a second model expression between models and generating the second model expression for a target head model.

According to an aspect of the disclosure, a model processing method includes, obtaining a first source head model in response to an obtained expression movement instruction, the first source head model including neutral feature data, and a plurality of pieces of expression feature data relative to the neutral feature data; performing deformation matching on the first source head model according to a first model feature of a first target head model, to obtain a second source head model subjected to deformation matching; determining a deformation parameter according to a first deformation relationship between the first source head model and the second source head model and a second deformation relationship from a first model expression to a second model expression in the first source head model, the first model expression being determined according to the neutral feature data of the first source head model, and the second model expression being determined according to expression feature data indicated by the expression movement instruction in the plurality of pieces of expression feature data; and performing expression transfer on the first target head model according to the deformation parameter, to obtain a second target head model having the second model expression.

According to an aspect of the disclosure, a model processing apparatus includes, at least one memory configured to store computer program code; and at least one processor configured to read the program code and operate as instructed by the program code, the program code including obtaining code configured to cause at least one of the at least one processor to obtain a first source head model in response to an obtained expression movement instruction, the first source head model including neutral feature data, and a plurality of pieces of expression feature data relative to the neutral feature data; deformation matching code configured to cause at least one of the at least one processor to perform deformation matching on the first source head model according to a first model feature of a first target head model, to obtain a second source head model subjected to deformation matching; model expression code configured to cause at least one of the at least one processor to determine a deformation parameter according to a first deformation relationship between the first source head model and the second source head model and a second deformation relationship from a first model expression to a second model expression in the first source head model, the first model expression being determined according to the neutral feature data of the first source head model, and the second model expression being determined according to expression feature data indicated by the expression movement instruction in the plurality of pieces of expression feature data; and expression transfer code configured to cause at least one of the at least one processor to perform expression transfer on the first target head model according to the deformation parameter, to obtain a second target head model having the second model expression.

According to an aspect of the disclosure, a non-transitory computer-readable storage medium, storing computer code which, when executed by at least one processor, causes the at least one processor to at least obtain a first source head model in response to an obtained expression movement instruction, the first source head model including neutral feature data, and a plurality of pieces of expression feature data relative to the neutral feature data; perform deformation matching on the first source head model according to a first model feature of a first target head model, to obtain a second source head model subjected to deformation matching; determine a deformation parameter according to a first deformation relationship between the first source head model and the second source head model and a second deformation relationship from a first model expression to a second model expression in the first source head model, the first model expression being determined according to the neutral feature data of the first source head model, and the second model expression being determined according to expression feature data indicated by the expression movement instruction in the plurality of pieces of expression feature data; and perform expression transfer on the first target head model according to the deformation parameter, to obtain a second target head model having the second model expression.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of blend shapes according to some embodiments.

FIG. 2 is a schematic flowchart of a model processing method according to some embodiments.

FIG. 3 is a schematic flowchart of another model processing method according to some embodiments.

FIG. 4 is a schematic diagram of reference facial key points in a two-dimensional face image according to some embodiments.

FIG. 5 is a schematic diagram of position coordinates of target triangles in a source head model and in a source head model subjected to deformation matching according to some embodiments.

FIG. 6 is a schematic diagram of performing expression transfer on a target head model according to some embodiments.

FIG. 7 is a schematic flowchart of another model processing method according to some embodiments.

FIG. 8 is a schematic diagram of feature regions according to some embodiments.

FIG. 9 is a schematic diagram of positioning and rotation of an eyeball region according to some embodiments.

FIG. 10 is a schematic diagram of performing expression transfer on a target head model according to some embodiments.

FIG. 11 is a schematic diagram of determining an eyelid region according to some embodiments.

FIG. 12 is a schematic diagram of a lower eyelid boundary and an upper eyelid boundary according to some embodiments.

FIG. 13 is a schematic diagram of adjusting an eyelid region according to some embodiments.

FIG. 14 is a schematic diagram of a texture coordinate relationship according to some embodiments.

FIG. 15 is a schematic diagram of performing expression transfer on an interaction model according to some embodiments.

FIG. 16 is a schematic diagram of an effect of expression transfer according to some embodiments.

FIG. 17 is a schematic diagram of an application scenario according to some embodiments.

FIG. 18 is a schematic structural diagram of a model processing apparatus according to some embodiments.

FIG. 19 is a schematic structural diagram of a model processing device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Computer vision is a science that studies how to use a machine to “see”, and is machine vision that a camera and a computer are used to replace human eyes to perform recognition, measurement, and the like on a target, and further perform graphic processing, so that the computer processes the target into an image for human eyes to observe, or an image transmitted to an instrument for detection. In the computer vision, which is a scientific discipline, related theories and technologies are researched, to attempt to establish an artificial intelligence system that can obtain information from an image or multi-dimensional data. Large model technologies have brought significant transformations to the development of computer vision technologies. Pre-trained models in vision fields such as Swin-Transformer, vision transformer (ViT), vision mixture-of-experts (V-MoE), and Masked Autoencoder (MAE) can be quickly and widely applied to downstream tasks through fine-tuning. The computer vision technologies may include technologies such as image processing, image recognition, image semantic understanding, image retrieval, optical character recognition (OCR), video processing, video semantic understanding, video content/behavior recognition, three-dimensional (3D) technology, three-dimensional object reconstruction, virtual reality, augmented reality, and simultaneous localization and mapping.

Based on the computer vision technologies mentioned above, some embodiments provide a model processing solution. A source head model may be obtained in response to an obtained expression movement instruction, and deformation matching may be performed on the source head model according to a model feature of a target head model. The target head model is a model to be subjected to expression transfer, to obtain a source head model subjected to deformation matching. The model feature refers to a physical feature of an object such as an eye, an ear, a mouth, and a nose included in the head, for example, a shape and size feature of the object such as the eye, the ear, the mouth, and the nose. The deformation parameter may be determined according to the source head model subjected to deformation matching and a deformation relationship from a first model expression to a second model expression in the source head model, and expression transfer may be performed on the target head model according to the deformation parameter, to obtain the target head model having the second model expression. The source head model is configured with neutral feature data, and a plurality of pieces of expression feature data relative to the neutral feature data; and the first model expression in the source head model is determined according to the neutral feature data of the source head model, and the second model expression in the source head model is determined according to expression feature data indicated by the expression movement instruction in the plurality of pieces of expression feature data.

The model processing solution may be performed by a model processing device, and the model processing device may be a terminal device or a server. The terminal device herein may include, but is not limited to: a computer, a smartphone, a tablet computer, a notebook computer, a smart home appliance, an in-vehicle terminal, a smart wearable device, and the like. The server herein may be an independent physical server, or may be a server cluster including a plurality of physical servers or a distributed system, or may be a cloud server that provides cloud computing services such as a cloud service, a cloud database, cloud computing, a cloud function, cloud storage, a network service, cloud communication, a middleware service, a domain name service, a security service, a content delivery network (CDN), big data, and an AI platform. In some embodiments, the model processing solution may be independently or cooperatively performed by any electronic device having computing power. The disclosure is not limited thereto. A model processing device is used as an example for description in subsequent embodiments of this application.

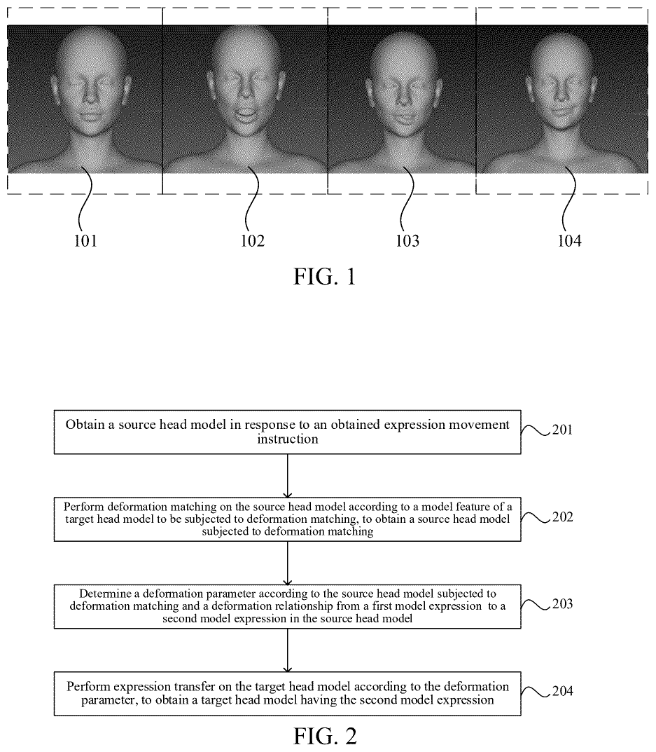

Various models mentioned in the model processing solution may be three-dimensional models, the three-dimensional models may be a set formed by a plurality of triangles, and vertices of the triangles are vertices of the three-dimensional models. The source head model may be a head model configured with neutral feature data and a plurality of pieces of expression feature data relative to the neutral feature data. The neutral feature data and the expression feature data herein refer to a blend shape (BS), and any piece of expression feature data may be obtained by performing deformation based on the neutral feature data. Various model expressions may be obtained based on the neutral feature data or based on one or more of the plurality of pieces of expression feature data through combination. Any model expression may also be considered as a blend shape. A combination of a plurality of blend shapes may also be considered as a blend shape. A model expression determined based on only the neutral feature data may be referred to as a neutral model expression. The first model expression in the source head model mentioned in the model processing solution is a neutral model expression determined according to the neutral feature data of the source head model. For example, one piece of expression feature data indicating “open mouth” may be combined with one piece of expression feature data indicating “closed eyes” to obtain one model expression indicating “open mouth and closed eyes”. FIG. 1 is a schematic diagram of blend shapes according to some embodiments. A blend shape indicated by label 101 is a “neutral” blend shape corresponding to neutral feature data, and a model expression corresponding to the blend shape is a neutral model expression. A blend shape indicated by label 102 is an “open mouth” blend shape corresponding to expression feature data indicating “open mouth”, and a model expression corresponding to the blend shape is a model expression indicating “open mouth”. A blend shape indicated by label 103 is a “bite lips” blend shape corresponding to expression feature data indicating “bite lips”, and a model expression corresponding to the blend shape is a model expression indicating “bite lips”. A blend shape indicated by label 104 is a “pursed lips” blend shape corresponding to expression feature data indicating “pursed lips”, and a model expression corresponding to the blend shape is a model expression indicating “pursed lips”.

In some embodiments, during example application of the relevant data (such as a source head model and a target head model) collection and processing, the informed consent or individual consent of a personal information subject should be obtained in strict accordance with the requirements of relevant laws and regulations, and the subsequent data use and processing behavior is carried out within the scope of authorization of laws and regulations and the personal information subject. When the technologies related to human faces (or other biometric features) are applied to products or technologies in the relevant embodiments of this application, the relevant data collection, use, and processing processes should comply with the requirements of laws and regulations. Before collecting facial information, the information processing rules should be informed and the individual consent of the corresponding subjects should be obtained. Facial information should be processed in strict accordance with the requirements of laws and regulations and personal information processing rules, and technical measures should be taken to ensure the security of relevant data.

Based on the model processing solution, some embodiments provide a model processing method. FIG. 2 is a schematic flowchart of a model processing method according to some embodiments. The model processing method shown in FIG. 2 may be performed by the model processing device mentioned above. The model processing method shown in FIG. 2 may include the following operations.

201: Obtain a source head model in response to an obtained expression movement instruction.

The source head model is configured with neutral feature data, and a plurality of pieces of expression feature data relative to the neutral feature data. The expression movement instruction may be configured for guiding the model processing device to generate a desired model expression for the source head model. An instruction format of the expression movement instruction may be set according to a requirement, for example, may be a text format or a speech format. The disclosure is not limited thereto. The model processing device may perform instruction analysis on the expression movement instruction to generate a model expression expected by the expression movement instruction for the source head model. In a feasible implementation, if the expression movement instruction is in a text format, when detecting that the expression movement instruction includes an expression keyword, the model processing device may generate a model expression indicated by the corresponding expression keyword for the source head model. For example, if detecting that the expression movement instruction includes an expression keyword “open mouth”, the model processing device may generate a model expression indicating “open mouth” for the source head model. In another feasible implementation, if the expression movement instruction is in a text format, the model processing device may perform semantic analysis on the expression movement instruction, and generate a semantically matching model expression for the source head model. For example, when obtaining through analysis that the expression movement instruction includes a semantic meaning of “surprise”, the model processing device may generate a model expression indicating “open mouth” that matches the semantic meaning for the source head model. The neutral feature data may be data of positions of face mesh vertices in a neutral case. A neutral face may be obtained through rendering based on the positions of the neutral face mesh vertices. The neutral face may be, for example, an expressionless face. The expression feature data may be data of positions of face mesh vertices under an expression. A face under an expression can be obtained through rendering based on the expression feature data. For example, with smile expression feature data, a smiling face can be obtained through rendering based on positions of face mesh vertices under the corresponding smile expression. In addition to positions of corresponding face mesh vertices, the neutral feature data and the expression feature data may further include table data. The table data stores a face formed by a plurality of vertices, for example, data of vertices forming a triangular face.

202: Perform deformation matching on the source head model according to a model feature of a target head model, to obtain a source head model subjected to deformation matching. The target head model is a model to be subjected to expression transfer. Model features of the source head model and the target head model are different. The model features may be, for example, facial features of a head model, where the facial features include features such as facial organs, a face shape, a chin, and cheekbones; or the model features are configured for distinguishing between different head models.

In some embodiments, the target head model may be a head model different from the source head model. For example, a face shape of the target head model may be different from that of the source head model, shapes of the facial organs of the target head model may be different from those of the source head model, a distribution of the facial organs of the target head model may be different from that of the source head model, and the like. The model processing device performs deformation matching on the source head model according to the model feature of the target head model, to perform deformation matching from the source head model to the target head model, for example, to adjust the source head model to approximate the target head model. For example, one or more of features such as a face shape, shapes of facial organs, and a distribution of facial organs of the source head model may approximate corresponding features of the target head model.

203: Determine a deformation parameter according to the source head model subjected to deformation matching and a deformation relationship from a first model expression to a second model expression in the source head model.

The first model expression in the source head model is determined according to the neutral feature data of the source head model. The first model expression in the source head model is a neutral model expression. The second model expression in the source head model is determined according to the expression feature data indicated by the expression movement instruction in the plurality of pieces of expression feature data. The second model expression in the source head model is a model expression generated by the model processing device according to the expression movement instruction. In the process of the model processing device performing instruction analysis on the expression movement instruction to generate a model expression expected by the expression movement instruction for the source head model, the model processing device may first perform instruction analysis on the expression movement instruction to determine expression feature data indicated by the expression movement instruction, and then generate a desired model expression (for example, the second model expression) based on the determined expression feature data. The second model expression is equivalent to an expression determined from a plurality of pieces of existing expression feature data according to the expression movement instruction. In a feasible implementation, if the expression movement instruction is in a text format, when detecting that the expression movement instruction includes an expression keyword, the model processing device may determine, based on the expression keyword, the expression feature data indicated by the expression movement instruction, and further generate a corresponding model expression based on the determined expression feature data. The foregoing manner in which the model processing device performs instruction analysis on the expression movement instruction to generate the model expression expected by the expression movement instruction for the source head model is an example. For example, when the expression movement instruction includes identifier information of the expression feature data, the model processing device may directly determine expression feature data indicated by the expression movement instruction based on the identifier information included in the expression movement instruction, and may further generate a corresponding model expression.

The deformation relationship between the source head model and the source head model subjected to deformation matching includes a transformation matrix from vertices of a target triangle in the source head model to the corresponding vertices in the source head model subjected to deformation matching. The transformation matrix between the vertices is determined according to an affine transformation parameter and a translation parameter. For calculation of the deformation relationship, reference may be made to related descriptions in subsequent embodiments.

204: Perform expression transfer on the target head model according to the deformation parameter, to obtain a target head model having the second model expression.

In some embodiments, the performing expression transfer according to the deformation parameter may include: adjusting, according to the deformation parameter, positions of feature points in the target head model having the first model expression, to obtain a target head model implementing the second model expression. When performing expression transfer on the target head model according to the deformation parameter, the model processing device performs, according to the deformation parameter, expression transfer on the target head model having the first model expression, for example, performs, according to the deformation parameter, expression transfer on the target head model having the neutral model expression. The first model expression in the target head model matches the target head model. The first model expression is determined according to the neutral feature data of the target head model, but is not determined according to the neutral feature data of the source head model. When performing expression transfer on the target head model according to the deformation parameter, the model processing device may adjust, according to the deformation parameter, the positions of the vertices in the target head model having the first model expression, to implement the second model expression based on the target head model. For example, if the second model expression in the source head model is a model expression indicating “open mouth”, the positions of the vertices in the target head model having the first model expression may be adjusted according to the deformation parameter, to implement the model expression indicating “open mouth” based on the target head model.

In some embodiments, after the expression movement instruction is obtained, starting from the source head model having the expressionless neutral feature data and the expression feature data, an expression change of the target head model is implemented through transfer based on expression transformation on the source head model. To implement expression transfer, deformation matching is first performed from the source head model to the target head model, so that the source head model subjected to deformation matching approximates the target head model, and the source head model having the neutral feature data and the expression feature data is close to the target head model in shape. A deformation parameter is determined according to the source head model subjected to deformation matching and a deformation relationship from the first model expression in the source head model to the second model expression indicated by the expression movement instruction, and the target head model having the current expression may be transformed into a target head model having the second model expression based on the deformation parameter. The second model expression can be automatically transferred from the source head model to the target head model. The second model expression can be automatically generated for the target head model. The second model expression in the source head model can be reused in different head models, further improving the efficiency of generating model expressions by different head models, and reducing human resource consumption.

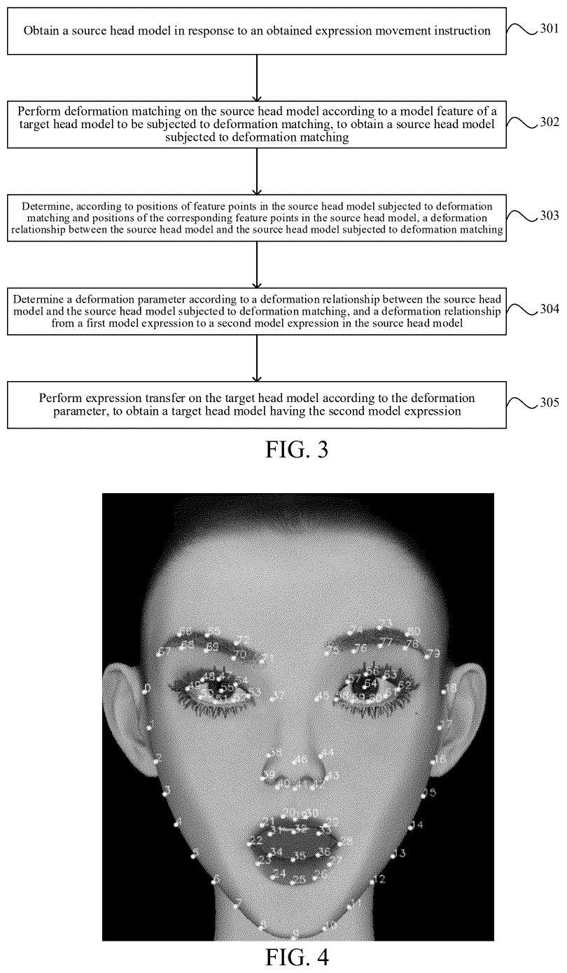

Based on the related embodiments of the foregoing model processing method, some embodiments provide another model processing method. FIG. 3 is a schematic flowchart of another model processing method according to some embodiments. The model processing method shown in FIG. 3 may be performed by the model processing device mentioned above. The model processing method shown in FIG. 3 may include the following operations.

301: Obtain a source head model in response to an obtained expression movement instruction.

The source head model is configured with neutral feature data, and a plurality of pieces of expression feature data relative to the neutral feature data. For additional implementation details of operation 301, reference may be made to the descriptions of operation 201.

302: Perform deformation matching on the source head model according to a model feature of a target head model, to obtain a source head model subjected to deformation matching.

In some embodiments, the model processing device performs deformation matching on the source head model according to the model feature of the target head model, to perform deformation matching from the source head model to the target head model, for example, to adjust the source head model to approximate the target head model. Adjusting the source head model to approximate the target head model may be understood as: performing rough alignment on the source head model through rigid translation, rotation, and scaling by using spatial positions of keypoints with same names on the source head model and the target head model, to make initial forms of the two models similar, meaning that the two models are substantially close to each other. For example, at least substantially, faces of the source head model and the target head model are similar in size and shape, such as both being both round faces and having face boundaries close to each other. Details of the face in the source head model are adjusted by using a plane distance of model vertices, a Euclidean distance between the keypoints with the same name in the two models, and a mesh deformation degree as metrics. By adjusting the keypoints of the source head model, a difference (for example, Euclidean distance) between coordinate positions of keypoints of the adjusted source head model on the adjusted source head model and coordinate positions of the corresponding keypoints (for example, the keypoints with the same name) in the target head model on the target head model satisfies a similarity condition (for example, it is considered that the similarity condition is satisfied if the Euclidean distances are less than a threshold). Deformation of a vertex mesh of the source head model is minimized, and a plane distance between a deformed vertex of the source head model and the target head model minimized. An optimal solution under such three constraints are obtained, and when the optimal solution is reached, the adjusted source head model is considered to approximate the target head model.

In some embodiments, based on positions of the vertices and the keypoints in the source head model and the vertices and the keypoints in the target head model, in a case that the positions of the vertices and the keypoints in the target head model are unchanged, the source head model with modified positions for each vertex and keypoints is calculated, and according to a plane distance of the vertices in the candidate source head model, a Euclidean distance between the keypoints with the same name in the candidate source head model and the target head model, and a mesh deformation degree of the candidate source head model, calculation is performed according to their respective preset weight values, to obtain a candidate source head model having a minimum value after weight calculation, which is determined as a target source head model. The target source head model is a source head model approximating the target head model. Position transformation may be performed on the source head model according to positions of vertices and keypoints in the target source head model, to obtain a source head model subjected to deformation matching, thereby completing deformation matching of the source head model. Values of the positions of the vertices and the keypoints in the source head model are modified, and modified values are incorporated into weight calculation, to obtain values of positions of the vertices and the keypoints when a minimum value is obtained, which are values of the vertices and the keypoints in the target source head model. Deformation matching of the source head model may be completed by performing position adjustment on the source head model according to the values of the vertices and the keypoints in the target source head model, to obtain a source head model approximating the target head model. The plane distance of the vertices in the candidate source head model is a distance from a vertex in the candidate source head model to the corresponding plane of the target head model. The reason for calculating the plane distance corresponding to the vertices in the source head model is that a vertex in the target head model closest to the vertex in the source head model is likely not a point in the target head model, but a point on a plane formed by points. The keypoints with the same name in the candidate source head model and the target head model may be, for example, keypoints numbered the same in the candidate source head model and the target head model, for example, keypoints with the same number of an eye corner key point, and keypoints with the same number of a nose tip key point. The mesh deformation degree of the candidate head model may be measured based on a difference between a rotation part in a transformation matrix and an identity matrix before and after deformation of a triangular face in the candidate source head model.

In some embodiments, the facial keypoints may be points that may be configured for indicating facial features, for example, may be points that indicate facial features such as a nose tip, an eyeball, a face contour, an eyebrow, and an eyelid. That the model processing device determines facial keypoints in the target head model may include: performing face detection on the target head model, to obtain detection keypoints corresponding to the target head model, performing keypoint annotation on the detection keypoints corresponding to the target head model by using reference facial keypoint distribution information, and determining annotated detection keypoints as the facial keypoints of the target head model. In some embodiments, face detection may be performed on the target head model by using a convolution neural network (CNN)-based face detection model. The facial keypoints may be detected by using the face detection model. In this process, another neural network model that can detect the facial keypoints may be used. The disclosure is not limited thereto. In some embodiments, the reference facial keypoint distribution information may be set according to a requirement, and may be distribution information of reference facial keypoints in a two-dimensional face image. The reference facial keypoints in the two-dimensional face image may be set according to a requirement. For example, a quantity and distribution positions of the reference facial keypoints in the two-dimensional face image may be set. The quantity of the reference facial keypoints in the two-dimensional face image may be set to 82, 76, or the like. For example, FIG. 4 is a schematic diagram of reference facial keypoints of a two-dimensional face image according to some embodiments, which may include reference facial keypoints indicating facial features such as a nose tip, eyeballs, a facial contour, eyebrows, and eyelids. The target head model on which face detection is performed may be obtained through rendering. If colorful textures or point coordinates are available, color rendering is used with natural lighting.

In some embodiments, that the model processing device performs deformation matching on the source head model according to the model feature of the target head model, to obtain the source head model subjected to deformation matching may include: determining a matching relationship between feature points in the source head model and feature points in the target head model according to positions of the feature points in the source head model and positions of the feature points in the target head model, where the feature points may include: one or two of vertices and facial keypoints in the corresponding models; and performing, according to the matching relationship and using the positions of the feature points in the target head model as reference positions, position adjustment on vertices forming the source head model, to obtain the source head model subjected to deformation matching, where distances between the positions of the feature points in the source head model subjected to deformation matching and the corresponding reference positions determined according to the matching relationship satisfy a proximity condition. The model processing device may adjustment the positions of the vertices forming the source head model according to the matching relationship, using a feature point position distance in the target head model as reference positions, and using reducing a distance between the positions of the feature points as a target, to obtain the source head model subjected to deformation matching, where the feature point position distance is a distance between the positions of the feature points in the source head model and reference positions corresponding to the corresponding feature points having a matching relationship in the target head model; and perform position adjustment on the vertices forming the source head model, so that the a distance between the positions of the feature points in the source head model subjected to deformation matching and the corresponding reference positions determined according to the matching relationship satisfies a proximity condition, where the proximity condition may be set according to a requirement.

Since the source head model and the target head model are two different models, a quantity of vertices in the source head model and positions of the vertices may be different from those of the target head model. The vertices in the source head model and the vertices in the target head model may have one or more of a plurality of correspondences such as one-to-one, one-to-many, many-to-one, and many-to-many correspondences. For example, when a quantity of vertices of an eyebrow region in the source head model exceeds a number of vertices of an eyebrow region in the target head model, a plurality of vertices of the eyebrow region in the source head model may correspond to one vertex of the eyebrow region in the target head model. When the feature point is a vertex, the model processing device may determine a matching relationship between vertices in the source head model and vertices in the target head model according to positions of the vertices in the source head model and positions of the vertices in the target head model, and determining the matching relationship between the vertices means determining a correspondence between the vertices. When the feature point is a facial keypoint, the model processing device may determine a matching relationship between facial keypoints in the source head model and facial keypoints in the target head model according to positions of the facial keypoints in the source head model and positions of the facial keypoints in the target head model, and determining the matching relationship between the facial keypoints means determining a correspondence between the facial keypoints. For example, it is determined that a matching relationship exists between a facial keypoint indicating a nose tip in the source head model and a facial keypoint indicating a nose tip in the target head model. A process of determining the facial keypoints in the source head model is similar to the process of determining the facial keypoints in the target head model.

The model processing device may perform, according to the matching relationship and using the positions of the feature points in the target head model as reference positions, position adjustment on vertices forming the source head model, to obtain the source head model subjected to deformation matching. Distances between the positions of the feature points in the source head model subjected to deformation matching and the corresponding reference positions determined according to the matching relationship satisfy a proximity condition. For example, the proximity condition may be set as follows: an average value of distances between positions of feature points in the source head model subjected to deformation matching and corresponding reference positions determined according to the matching relationship is less than a first threshold. For another example, the proximity condition may be set as follows: a sum of distances between positions of feature points in the source head model subjected to deformation matching and corresponding reference positions determined according to the matching relationship is less than a second threshold. The first threshold and the second threshold may be set according to a requirement.

In some embodiments, when the vertices and the facial keypoints are both selected as feature points, the model processing device may first perform position adjustment on vertices forming the source head model based on a matching relationship between the facial keypoints, to obtain an intermediate source head model, and further continue to perform position adjustment on vertices in the intermediate source head model based on a matching relationship between the vertices, to obtain a source head model subjected to deformation matching. During the position adjustment on the vertices forming the source head model based on the matching relationship between the facial keypoints, a distance between the facial keypoints may be used as a metric. Positions of feature points (for example, facial keypoints) in the target head model are used as reference positions, and reducing a feature point position distance based on the facial keypoints is used as a deformation target. The process can be implemented by performing rigid translation, rotation, and scaling on the source head model. The process is expected to enable the intermediate source head model and the target head model to have consistent initial states, for example, consistent head orientations and sizes. When position adjustment continues to be performed on the vertices in the intermediate source head model based on a matching relationship between vertices, a distance between the vertices may be used as a metric. Positions of feature points (for example, vertices) in the target head model are used as reference positions, and reducing a feature point position distance based on the vertices is used as a deformation target. In some embodiments, a distance between keypoints and a distance between vertices may be jointly used as metrics. Positions of feature points (for example, vertices and facial keypoints) in the target head model are used as reference positions, and reducing a feature point position distance when the feature points are the vertices and reducing a feature point position distance when the feature points are the facial keypoints are used as deformation targets. In some embodiments, the distance between the vertices may be a distance between vertices having a matching relationship (for example, a feature point position distance based on the vertices), or may be a point-plane distance of the vertices.

303: Determine, according to positions of feature points in the source head model subjected to deformation matching and positions of the corresponding feature points in the source head model, a deformation relationship between the source head model and the source head model subjected to deformation matching, the feature points including one or more of vertices and facial keypoints.

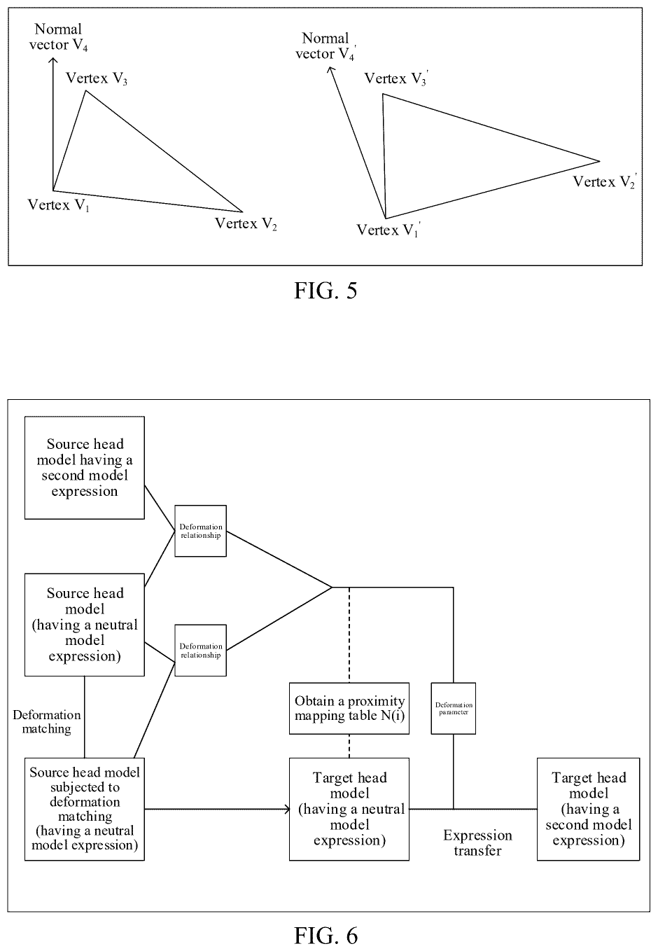

In some embodiments, the model processing device determines the deformation relationship between the source head model and the source head model subjected to deformation matching according to the positions of feature points in the source head model subjected to deformation matching and the positions of the corresponding feature points in the source head model, to determine vertex deformation relationship between the vertices in the source head model and the corresponding vertices in the source head model subjected to deformation matching, for example, a transformation matrix (which may also be referred to as a deformation field) from the vertices in the source head model to the corresponding vertices in the source head model subjected to deformation matching. A target triangle and vertices of the target triangle in the source head model are used as an example for description. The target triangle may be any triangle in the source head model. For example, FIG. 5 is a schematic diagram of position coordinates of target triangles in a source head model and in a source head model subjected to deformation matching according to some embodiments. Position coordinates of three vertices of the target triangle in the source head model are respectively represented as: position coordinates V₁ of the first vertex, position coordinates V₂ of the second vertex, and position coordinates V₃ of the third vertex, and V₄ represents a normal vector of the target triangle. Position coordinates of the three vertices of the target triangle in the source head model subjected to deformation matching are respectively represented as: position coordinates V′₁ of the first vertex, position coordinates V′₂ of the second vertex, and position coordinates V′₃ of the third vertex, and V′₄ represents a normal vector of the target triangle. The model processing device may determine the normal vector of the target triangle according to positions of vertices of the target triangle in the source head model, and further determine a local coordinate system of the target triangle according to the positions of the vertices and the normal vector of the target triangle in the source head model.

The normal vector of the target triangle in the source head model may be expressed by the following formula 1.1:

$${V}_{4} = {V}_{1} + ( {V}_{2} - {V}_{1} ) \times ( {V}_{3} - {V}_{1} ) \sqrt{\vert ( {V}_{2} - {V}_{1} ) \times ( {V}_{3} - {V}_{1} ) \vert} \qquad ( 1.1 )$$

The local coordinate system of the target triangle in the source head model may be expressed by the following formula 1.2:

$$V = [ \begin{matrix}{V}_{2} - {V}_{1} & {V}_{3} - {V}_{1} & {V}_{4} - {V}_{1}\end{matrix} ] \qquad ( 1.2 )$$

The model processing device may determine the normal vector of the target triangle according to the positions of the vertices of the target triangle in the source head model subjected to deformation matching, and further determine a local coordinate system of the target triangle according to the positions of the vertices and the normal vector of the target triangle in the source head model subjected to deformation matching.

The normal vector of the target triangle in the source head model subjected to deformation matching may be expressed by the following formula 2.1:

$${V}_{4}^{′} = {V}_{1}^{′} + ( {V}_{2}^{′} - {V}_{1}^{′} ) \times ( {V}_{3}^{′} - {V}_{1}^{′} ) \sqrt{\vert ( {V}_{2}^{′} - {V}_{1}^{′} ) \times ( {V}_{3}^{′} - {V}_{1}^{′} ) \vert} \qquad ( 2.1 )$$

The local coordinate system of the target triangle in the source head model subjected to deformation matching may be expressed by the following formula 2.2:

$${V}^{′} = [ \begin{matrix}{V}_{2}^{′} - {V}_{1}^{′} & {V}_{3}^{′} - {V}_{1}^{′} & {V}_{4}^{′} - {V}_{1}^{′}\end{matrix} ] \qquad ( 2.2 )$$

A spatial affine transformation parameter Q and a translation parameter t are defined, and applied to the three vertices of the target triangle in the source head model, so that position coordinates of the three vertices of the target triangle in the source head model subjected to deformation matching are correspondingly obtained. A correspondence between position coordinates of the vertices of the target triangle in the source head model and the corresponding vertices of the target triangle in the source head model subjected to deformation matching may be expressed by the following formula 3:

$$Q * {V}_{i} + t = {V}_{i}^{′} \qquad ( 3 )$$

i represents an independent variable for the vertices of the target triangle, and iϵ[1, 3].

The model processing device may determine the affine transformation parameter according to the local coordinate system of the target triangle in the source head model and the local coordinate system of the target triangle in the source head model subjected to deformation matching. The translation parameter is determined according to the positions of the vertices of the target triangle in the source head model and the positions of the vertices of the target triangle in the source head model subjected to deformation matching. The affine transformation parameter Q may be expressed by the following formula 4, and the translation parameter t may be expressed by the following formula 5:

$$Q = {V}^{′} {V}^{- 1} \qquad ( 4 )$$

$$t = [ \begin{matrix}{V}_{1}^{′} - {V}_{1} & {V}_{2}^{′} - {V}_{2} & {V}_{3}^{′} - {V}_{3}\end{matrix} ] \qquad ( 5 )$$

The model processing device may determine, according to the determined affine transformation parameter and the determined translation parameter, the vertex deformation relationship between the vertices of the target triangle in the source head model and the corresponding vertices in the source head model subjected to deformation matching, for example, the transformation matrix from the vertices of the target triangle in the source head model to the corresponding vertices in the source head model subjected to deformation matching. When the target triangle is an i^{th} triangle in the plurality of triangles in the source head model, a transformation matrix from vertices of the target triangle in the source head model to the corresponding vertices in the source head model subjected to deformation matching may be expressed by the following formula 6. The transformation matrix includes a vertex deformation relationship between three vertices in the i^{th} triangle:

$${T}_{i}^{″} = [ {Q}_{i} , {t}_{i} ] \qquad ( 6 )$$

Qᵢ represents an affine transformation parameter corresponding to the i^{th} triangle determined according to a local coordinate system of the i^{th} triangle in the source head model and a local coordinate system of the i^{th} triangle in the source head model subjected to deformation matching, tᵢ represents a translation parameter corresponding to the i^{th} triangle determined according to positions of vertices of the i^{th} triangle in the source head model and positions of vertices of the i^{th} triangle in the source head model subjected to deformation matching, and T″ᵢ represents a transformation matrix from vertices of the i^{th} triangle in the source head model to the corresponding vertices in the source head model subjected to deformation matching, for example, a transformation matrix from the i^{th} triangle in the source head model to the i^{th} triangle in the source head model subjected to deformation matching.

304: Determine the deformation parameter according to the deformation relationship between the source head model and the source head model subjected to deformation matching, and the deformation relationship from the first model expression to the second model expression in the source head model.

The first model expression in the source head model is determined according to the neutral feature data of the source head model, and the second model expression in the source head model is determined according to expression feature data indicated by the expression movement instruction in the plurality of pieces of expression feature data. The first model expression may be obtained through rendering according to positions of vertices included in the neutral feature data. The first model expression may be, for example, a face without a common expression. The source head model may be correspondingly provided with a plurality of pieces of expression feature data having a common expression, for example, smile expression feature data and grin expression feature data. Expression feature data of a common expression can be determined from the plurality of pieces of expression feature data based on the expression movement instruction. The plurality of pieces of expression feature data can be rendered to obtain corresponding expressions. For example, if the expression movement instruction indicates a smile instruction, the second model expression is a smile expression.

The deformation relationship from the first model expression to the second model expression in the source head model may be determined according to the positions of the feature points in the source head model having the second model expression and the positions of the corresponding feature points in the source head model having the first model expression to determine a vertex deformation relationship between the vertices in the source head model having the first model expression and the corresponding vertices in the source head model having the second model expression, for example, a transformation matrix (which may also be referred to as a deformation field) from the vertices in the source head model having the first model expression to the corresponding vertices in the source head model having the second model expression. The process is similar to the foregoing process of determining the deformation relationship between the source head model and the source head model subjected to deformation matching.

In some embodiments, the deformation parameter may include vertex deformation parameters of vertices in the target head model. Determining a vertex deformation parameter of a target vertex in the target head model is used as an example. The target vertex may be any vertex in the target head model. That the model processing device determines a deformation parameter according to the deformation relationship between the source head model and the source head model subjected to deformation matching and the deformation relationship from the first model expression to the second model expression in the source head model may include: determining, according to the deformation relationship between the source head model and the source head model subjected to deformation matching, a first vertex deformation relationship between reference vertices in the source head model and the corresponding vertices in the source head model subjected to deformation matching; determining, according to the deformation relationship from the first model expression to the second model expression in the source head model, a second vertex deformation relationship between reference vertices in the source head model having the first model expression and the corresponding vertices in the source head model having the second model expression; and determining a vertex deformation parameter of a target vertex corresponding to the reference vertices in the target head model according to the first vertex deformation relationship of the reference vertices and the second vertex deformation relationship of the reference vertices. If the target vertex is an i^{th} vertex in the target head model, where iϵ[1, a quantity of vertices in the target head model], a vertex deformation parameter of the target vertex in the target head model may be expressed by the following formulas 7.1 and 7.2:

$${T}_{i} = {\sum }_{j ∈ N ( i )} {w}_{i , j} {T}_{j}^{′} {T}_{j}^{″} \qquad ( 7.1 )$$

$$\sum i ∈ N ( i ) {w}_{i , j} = 1 \qquad ( 7.2 )$$

N(i) represents a reference triangle index set formed by indexes of reference triangles corresponding to the target vertex (for example, the i^{th} vertex) in the target head model in the source head model. The reference vertices corresponding to the target vertex (for example, the i^{th} vertex) in the source head model are vertices of the reference triangles. In some embodiments, the reference triangle may be the nearest triangle in the source head model corresponding to the i^{th} vertex in the target head model.
T″ⱼ represents a transformation matrix from vertices of a j^{th} triangle in the source head model to the corresponding vertices in the source head model subjected to deformation matching, for example, a transformation matrix from the j^{th} triangle in the source head model to the j^{th} triangle in the source head model subjected to deformation matching, and T represents a transformation matrix from vertices of a j^{th} triangle in the source head model having the first model expression to the corresponding vertices in the source head model having the second model expression, for example, a transformation matrix from a j^{th} triangle in the source head model having the first model expression to a j^{th} triangle in the source head model having the second model expression. w_{i,j} represents that an i^{th} vertex in the target head model corresponds to a proximity weight of a j^{th} triangular face in the source head model, and may be set according to a requirement.

305: Perform expression transfer on the target head model according to the deformation parameter, to obtain a target head model having the second model expression.

In a feasible implementation, an operation of performing, by the model processing device, expression transfer on the target head model according to the deformation parameter, to obtain the target head model having the second model expression may include: adjusting, according to the vertex deformation parameters of the vertices in the target head model, positions of corresponding vertices in the target head model having the first model expression, to obtain the target head model having the second model expression. An example in which the target vertex in the target head model (having the first model expression) is the i^{th} vertex is used, and a process of adjusting the position of the target vertex according to the vertex deformation parameter of the target vertex in the target head model may be expressed by the following formula 8:

$${v}_{i}^{* *} = {T}_{i} {v}_{i}^{*} \qquad ( 8 )$$

v*ᵢ represents a position of a target vertex (for example, an i^{th} vertex) in the target head model, and v**ᵢ represents a position of an adjusted target vertex.

FIG. 6 is a schematic diagram of performing expression transfer on a target head model according to some embodiments. After obtaining the source head model and the target head model, the model processing device may perform deformation matching on the source head model (having the first model expression, for example, having the neutral model expression) according to a model feature of the target head model (having the first model expression, for example, having the neutral model expression), to obtain the source head model subjected to deformation matching, where the source head model subjected to deformation matching approximates the target head model. The model processing device may determine a deformation relationship between the source head model and the source head model subjected to deformation matching and a deformation relationship from the first model expression to the second model expression in the source head model, determine a deformation parameter according to the determined two deformation relationships, and perform expression transfer on the target head model according to the deformation parameter, to obtain the target head model having the second model expression, thereby implementing the second model expression of the target head model, for example, implementing transfer of the second model expression from the source head model to the target head model. In the source head model, indexes of reference triangles corresponding to the target vertex in the target head model may be represented by a proximity mapping table corresponding to the target vertex. In the process of determining the vertex deformation parameter of the vertices in the target head model, the model processing device may obtain a proximity mapping table corresponding to the corresponding vertices, determine the vertex deformation parameter of the corresponding vertices based on the proximity mapping table and the two determined deformation relationships, and adjust the corresponding vertices based on the vertex deformation parameter.

In some embodiments, the second model expression can be automatically transferred from the source head model to the target head model. The second model expression can be automatically generated for the target head model. The second model expression in the source head model can be reused in different head models, further improving the efficiency of generating model expressions by different head models, and reducing human resource consumption. In the process of determining the deformation relationship, the deformation relationship between the source head model and the source head model subjected to deformation matching is determined according to the positions of the feature points in the source head model subjected to deformation matching and the positions of the corresponding feature points in the source head model. The deformation parameter may be determined according to the deformation relationship between the source head model and the source head model subjected to deformation matching and the deformation relationship from the first model expression to the second model expression in the source head model. The deformation relationship and the deformation parameter are determined by using the feature points in the model as analyzed objects, improving the accuracy and efficiency of model deformation. Determining a complete expression deformation parameter according to the deformation relationship from the first model expression to the second model expression in the source head model may cause the determined deformation parameter to mismatch the target head model since the source head model and the target head model have different facial features, causing a poor effect of the second model expression transferred to the target head model. In this solution, the source head model subjected to deformation matching approximates the target head model, and deformation of the target head model may be controlled according to a deformation relationship corresponding to an expression change in the source head model. By implementing expression transformation on the target head model based on the deformation relationship of the feature points rather than a deformation relationship of pixel points, the efficiency of matching between the determined deformation parameter and the target head model can be improved, and an effect of expression transfer based on the deformation parameter is further improved, for example, an effect of the second model expression transferred to the target head model may be improved.

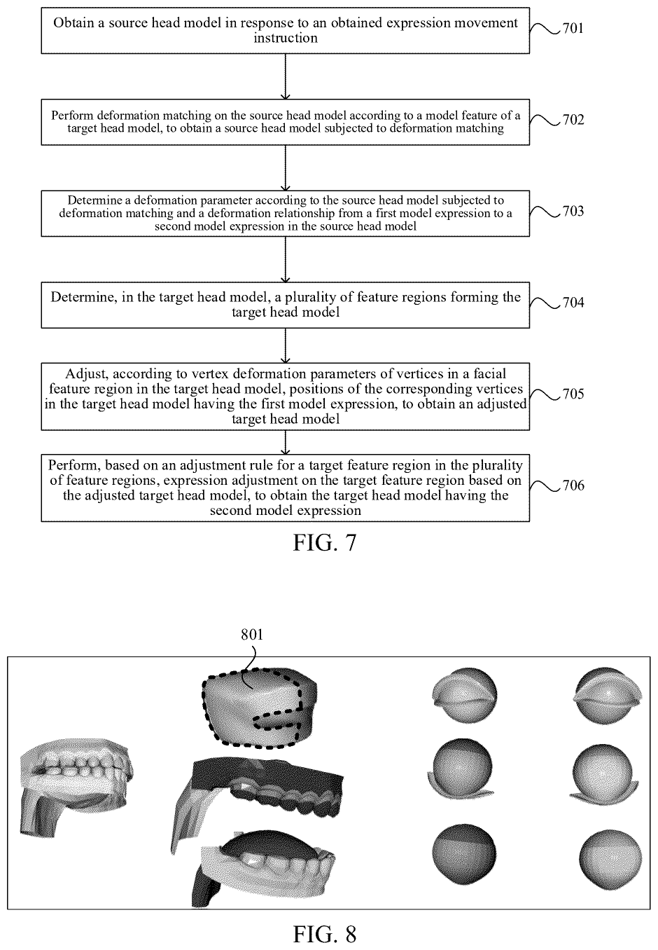

Based on the related embodiments of the foregoing model processing method, some embodiments provide another model processing method. FIG. 7 is a schematic flowchart of another model processing method according to some embodiments. The model processing method shown in FIG. 7 may be performed by the model processing device mentioned above. The model processing method shown in FIG. 7 may include the following operations.

701: Obtain a source head model in response to an obtained expression movement instruction.

The source head model is configured with neutral feature data, and a plurality of pieces of expression feature data relative to the neutral feature data.

702: Perform deformation matching on the source head model according to a model feature of a target head model, to obtain a source head model subjected to deformation matching.

703: Determine a deformation parameter according to the source head model subjected to deformation matching and a deformation relationship from a first model expression to a second model expression in the source head model.

The first model expression in the source head model is determined according to the neutral feature data of the source head model, and the second model expression in the source head model is determined according to expression feature data indicated by the expression movement instruction in the plurality of pieces of expression feature data. The deformation parameter includes vertex deformation parameters of vertices of a facial feature region in the target head model. A process related to operation 701 to operation 703 is similar to a process related to operation 201 to operation 203 and a process related to operation 301 to operation 304.

704: Determine, in the target head model, a plurality of feature regions forming the target head model.

In some embodiments, that the model processing device determines, in the target head model, a plurality of feature regions forming the target head model may include: determining connected regions (communicated regions) of the target head model in the target head model, and determining coinciding boundaries between the connected regions; and performing region merging on the connected regions according to determined lengths of the coinciding boundaries, and determining a plurality of connected regions obtained through the region merging as the plurality of feature regions. In some embodiments, when performing region merging on the connected regions according to the determined lengths of the coinciding boundaries, the model processing device may perform region merging on the corresponding connected regions in a case that the determined lengths of the coinciding boundaries are greater than a length threshold, or perform region merging on the corresponding connected regions in a case that a proportion of the determined lengths of the coinciding boundaries to a length of a boundary of the corresponding connected regions is greater than a coincidence proportion threshold. The length threshold and the coincidence proportion threshold may be set according to a requirement. FIG. 8 is a schematic diagram of feature regions according to some embodiments. For example, a feature region may be indicated by label 801.

705: Adjust, according to vertex deformation parameters of vertices in a facial feature region in the target head model, positions of the corresponding vertices in the target head model having the first model expression, to obtain an adjusted target head model.

The facial feature region is a feature region having a largest surface area in the plurality of feature regions; and the feature region having the largest surface area in the plurality of feature regions is determined as the facial feature region because connected regions formed by the face and the head have a largest actual surface area rather than a largest number of vertices. A related process in which the model processing device adjusts, according to the vertex deformation parameters of the vertices in the facial feature region in the target head model, the positions of the corresponding vertices in the target head model having the first model expression is similar to the related process in operation 305 of adjusting, according to the vertex deformation parameters of the vertices in the target head model, the positions of the corresponding vertices in the target head model having the first model expression. The process is a face sculpting process, and the positions of the vertices in the facial feature region in the target head model are changeable.

706: Perform, based on an adjustment rule for a target feature region in the plurality of feature regions, expression adjustment on the target feature region based on the adjusted target head model, to obtain the target head model having the second model expression.

In some embodiments, the target feature region may be any of the plurality of feature regions other than the facial feature region, for example, may be a feature region indicating an eyebrow, a feature region indicating an eyelash, or a feature region indicating a tongue. That the model processing device performs, based on the adjustment rule for the target feature region in the plurality of feature regions, expression adjustment on the target feature region may include: determining a linked feature region corresponding to the target feature region from the plurality of feature regions; and performing follow-up adjustment on the target feature region according to adjustment of the linked feature region based on an instruction of the adjustment rule for the target feature region. Expression adjustment may be performed on the target feature region, based on the adjustment rule for the target feature region, following the adjustment of the linked feature region.

The linked feature region corresponding to the target feature region may be a feature region that may be configured for guiding the target feature region to perform expression adjustment in the plurality of feature regions. The facial feature region may be determined as the linked feature region corresponding to the target feature region. That the model processing device performs follow-up adjustment on the target feature region according to the adjustment of the linked feature region based on the instruction of the adjustment rule for the target feature region may include: if an overlapping area between the target feature region and the linked feature region is less than an area threshold, adjusting positions of vertices in the target feature region according to a rigid adjustment method, following the adjustment of positions of vertices in the linked feature region; or if the overlapping area between the target feature region and the linked feature region is greater than or equal to the area threshold, adjusting the positions of the vertices in the target feature region according to a Laplace's method, following the adjustment of the positions of the vertices in the linked feature region. The area threshold may be set according to a requirement, and the rigid adjustment method includes rigid rotation and translation. For example, if the target feature region is a feature region indicating an eyebrow, a linked feature region corresponding to the feature region indicating the eyebrow is a facial feature region, and an overlapping area between the feature region indicating the eyebrow and the facial feature region is less than an area threshold, positions of vertices in the feature region indicating the eyebrow are adjusted according to the rigid adjustment method, following the adjustment of positions of vertices in the facial feature region. After the target feature region for expression transformation is determined, in some embodiments, a feature region linked to the target feature region is further correspondingly determined. When expression transformation adjustment is performed on the target feature region, the linked feature region moves, making the expression transformation more natural.

In a feasible implementation, in when the positions of the vertices in the target feature region are adjusted according to the rigid adjustment method, following the adjustment of the positions of the vertices in the linked feature region, a rigid adjustment parameter may be determined according to positions of the vertices before the linked feature region is adjusted and positions of the vertices after the linked feature region is adjusted, and rigid adjustment is performed on the positions of the vertices in the target feature region based on the rigid adjustment parameter. When the linked feature region is a facial feature region, the positions of the vertices before the linked feature region is adjusted are the positions of the vertices in the facial feature region in the target head model, and the positions of the vertices after the linked feature region is adjusted are positions of vertices in the facial feature region in the adjusted target head model. When the rigid adjustment parameter is determined according to the positions of the vertices before the linked feature region is adjusted and the positions of the vertices after the linked feature region is adjusted, according to a first point cloud matrix formed by the positions of the vertices before the linked feature region is adjusted and a second point cloud matrix formed by the positions of the vertices after the linked feature region is adjusted, center points of the first point cloud matrix and the second point cloud matrix may be determined; and a decentralized first point cloud matrix is determined according to the first point cloud matrix and the corresponding center point, a decentralized second point cloud matrix is determined according to the second point cloud matrix and the corresponding center point; and singular value decomposition (SVD) may be further performed on the decentralized first point cloud matrix and the decentralized second point cloud matrix, to obtain a rotation matrix and a translation parameter. The rotation matrix and the translation parameter obtained through decomposition form the rigid adjustment parameter.

In some embodiments, an example in which the linked feature region is a facial feature region is used. The facial feature region before adjustment may be considered as a mesh component corresponding to a neutral model expression, and the facial feature region after adjustment may be considered as a mesh component corresponding to a non-neutral model expression. The first point cloud matrix formed by the positions of the vertices before the linked feature region is adjusted may be expressed by the following formula 9.1, and the second point cloud matrix formed by the positions of the vertices after the linked feature region is adjusted may be expressed by the following formula 9.2. If vertices in the linked feature region are counted from 0, [x₀ y₀ z₀] represents position coordinates (for example, x-axis, y-axis, and z-axis coordinates) of a vertex with a count of 0 before the linked feature region is adjusted, and [xₙ yₙ zₙ] represents position coordinates (for example, x-axis, y-axis, and z-axis coordinates) of a vertex with a count of n before the linked feature region is adjusted. Since the vertices in the linked feature region are counted from 0, n is a value obtained by subtracting 1 from a quantity of vertices in the linked feature region, for example, n+1 represents the quantity of vertices in the linked feature region. [x′₀ y′₀ z′₀] represents position coordinates (for example, x-axis, y-axis, and z-axis coordinates) of a vertex with a count of 0 after the linked feature region is adjusted; and [x′ₙ y′ₙ z′ₙ] represents position coordinates (for example, x-axis, y-axis, and z-axis coordinates) of a vertex with a count of n after the linked feature region is adjusted.

$${P}_{src} = [ \begin{matrix}{x}_{0} & {y}_{0} & {z}_{0} \\ ⋮ & ⋮ & ⋮ \\ {x}_{n} & {y}_{n} & {z}_{n}\end{matrix} ] \qquad ( 9.1 )$$

$${P}_{tgt} = [ \begin{matrix}{x}_{0}^{′} & {y}_{0}^{′} & {z}_{0}^{′} \\ ⋮ & ⋮ & ⋮ \\ {x}_{n}^{′} & {y}_{n}^{′} & {z}_{n}^{′}\end{matrix} ] \qquad ( 9.2 )$$

The center point of the first point cloud matrix may be expressed by the following formula 9.3, and the center point of the second point cloud matrix may be expressed by the following formula 9.4:

$${\overline{P}}_{s r c} = \frac{1}{n + 1} [ {\sum }_{i = 0}^{n} {x}_{i} , {\sum }_{i = 0}^{n} {y}_{n} , {\sum }_{i = 0}^{n} {z}_{n} ] \qquad ( 9.3 )$$

$${\overline{P}}_{t g t} = \frac{1}{n + 1} [ {\sum }_{i = 0}^{n} {x}_{i}^{′} , {\sum }_{i = 0}^{n} {y}_{n}^{′} , {\sum }_{i = 0}^{n} {z}_{n}^{′} ] \qquad ( 9.4 )$$

The decentralized first point cloud matrix may be expressed by the following formula 9.5, and the decentralized second point cloud matrix may be expressed by the following formula 9.6:

$${P}_{src}^{′} = {P}_{src} - {\overline{P}}_{src} \qquad ( 9.5 )$$

$${P}_{tgt}^{′} = {P}_{tgt} - {\overline{P}}_{t g t} \qquad ( 9.6 )$$

A correspondence obtained by performing singular value decomposition on the decentralized first point cloud matrix and the decentralized second point cloud matrix may be expressed by the following formula 9.7, the rotation matrix (R) obtained through decomposition may be expressed by the following formula 9.8, and the translation parameter (t) may be expressed by the following formula 9.9:

$${( {P}_{t g t}^{′} )}^{T} {P}_{src}^{′} = {U}^{T} SV \qquad ( 9.7 )$$

$$R = {U}^{T} \cdot V \qquad ( 9.8 )$$

$$t = - {Rp}_{src}^{- T} + {p}_{tgt}^{- T} \qquad ( 9.9 )$$

U represents a left unitary matrix, S represents a non-negative real diagonal matrix, and V represents a right unitary matrix.

In some embodiments, the linked feature region corresponding to the target feature region may be a feature region that may be configured for guiding the target feature region to perform expression adjustment in the plurality of feature regions. The facial feature region may be determined as the linked feature region corresponding to the target feature region. When the target feature region belongs to an eyeball accessory region, the linked feature region corresponding to the target feature region may be the eyeball region determined in the plurality of feature regions (for example, the plurality of feature regions may include the eyeball region). The model processing device may determine the eyeball region and the eyeball accessory region from the plurality of feature regions. The eyeball accessory region is a feature region indicating an eyeball accessory. The eyeball accessory may include structural components related to the eyeball, such as eyeball contents, an eyelid, an eyelash, and an eyebrow.

A manner in which the model processing device determines the eyeball region from the plurality of feature regions includes: determining center points and spherical similarities of the feature regions; and determining the eyeball region from the plurality of feature regions according to distances between the center points of the feature regions and eyeball keypoints in facial keypoints of the adjusted target head model and degrees of resembling a sphere indicated by the spherical similarities of the feature regions. The spherical similarity (circularity) is also referred to as sphericity, and can measure a degree to which an object resembles a sphere, and the spherical similarity of a feature region is configured for indicating a degree to which the corresponding feature region resembles a sphere.

That the model processing device determines the center points and the spherical similarities of the feature regions may include: determining, for a currently traversed feature region in the feature regions, a center point of the currently traversed feature region according to positions of vertices in the currently traversed feature region; determining, according to the positions of the vertices in the currently traversed feature region and a position of the center point, radii of distances from the vertices in the currently traversed feature region to the center point, and an average radius corresponding to the vertices in the currently traversed feature region; and determining the spherical similarity of the currently traversed feature region according to differences between the radii of distances from the vertices in the currently traversed feature region to the center points and the average radius. An average value of absolute values of differences between the radii of distances from the vertices in the currently traversed feature region to the corresponding center points and the average radius may be used as the spherical similarity of the currently traversed feature region.

When determining the center point of the currently traversed feature region according to the positions of the vertices in the currently traversed feature region, the model processing device may perform averaging processing on the positions of the vertices in the currently traversed feature region, and determine a position obtained through averaging processing as a position of the center point of the currently traversed feature region. The position of the center point of the currently traversed feature region may be expressed by the following formula 10.1, formula 10.2, and formula 10.3, where N represents a quantity of vertices in the currently traversed feature region, and i is an independent variable. If the vertices in the currently traversed feature region are counted from 0, xᵢ represents an x-axis coordinate in a position of a vertex with a count of i in the currently traversed feature region, yᵢ represents a y-axis coordinate in the position of the vertex with a count of i in the currently traversed feature region, zᵢ represents a z-axis coordinate of the position of the vertex with a count of i in the currently traversed feature region, and x̅, y̅, and z̅ respectively represent x-axis, y-axis, and z-axis coordinates of the position of the center point of the currently traversed feature region:

$$\overline{x} = \frac{1}{N} {\sum }_{i = 0}^{N - 1} {x}_{i} \qquad ( 10.1 )$$

$$\overline{y} = \frac{1}{N} {\sum }_{i = 0}^{N - 1} {y}_{i} \qquad ( 10.2 )$$

$$\overline{z} = \frac{1}{N} {\sum }_{i = 0}^{N - 1} {z}_{i} \qquad ( 10.3 )$$

When the model processing device determines, according to the positions of the vertices in the currently traversed feature region and the position of the center point, the radii of distances from the vertices in the currently traversed feature region to the center point, and the average radius corresponding to the vertices in the currently traversed feature region, a radius of a distance from any vertex in the currently traversed feature region to the corresponding center point may be a distance between the any vertex and the corresponding center point, and the average radius corresponding to the vertices in the currently traversed feature region is obtained by performing averaging processing on the radii of distances from the vertices in the currently traversed feature region to the corresponding center point. A radius of a distance from a vertex in the currently traversed feature region to the corresponding center point may be expressed by the following formula 10.4, and the average radius corresponding to the vertices in the currently traversed feature region may be expressed by the following formula 10.5. Rᵢ represents a radius of a distance from the vertex with a count of i in the currently traversed feature region to the corresponding center point, and R̅ represents the average radius corresponding to the vertices in the currently traversed feature region.

$${R}_{i} = \sqrt{{( {x}_{i} - \overline{x} )}^{2} + {( {y}_{i} - \overline{y} )}^{2} + {( {z}_{i} - \overline{z} )}^{2}} \qquad ( 10.4 )$$

$$\overline{R} = \frac{1}{N} {\sum }_{i = 0}^{N - 1} {R}_{i} \qquad ( 10.5 )$$

The model processing device may determine the spherical similarity of the currently traversed feature region according to the difference between the radii of distances from the vertices in the currently traversed feature region to the corresponding center point and the average radius. For example, an average value of absolute values of differences between the radii of distances from the vertices in the currently traversed feature region to the corresponding center point and the average radius may be used as the spherical similarity of the currently traversed feature region. The spherical similarity of the currently traversed feature region may be expressed by the following formula 10.6. Circularity represents the spherical similarity:

$$Circularity = \frac{1}{N} {\sum }_{i = 0}^{N - 1} ‖ {R}_{i} - \overline{R} ‖ \qquad ( 10.6 )$$

It can be known from formula 10.6 that the spherical similarity of a feature region is negatively correlated with a degree to which the corresponding feature region resembles a sphere. The model processing device determines the eyeball region from the plurality of feature regions according to distances between the center points of the feature regions and eyeball keypoints in facial keypoints of the adjusted target head model and degrees of resembling a sphere indicated by the spherical similarities of the feature regions, which may include: determining the feature regions with the spherical similarity less than a similarity threshold in the feature regions as candidate eyeball regions; determining the distances between the center points of the candidate eyeball regions and the eyeball keypoints in the facial keypoints of the adjusted target head model; and determining the candidate eyeball region indicated by a smallest distance in the candidate eyeball regions as the eyeball region. The similarity threshold may be set according to a requirement, and the eyeball keypoint is a facial keypoint that may indicate an eyeball. Since the eyeball may include a left eyeball and a right eyeball, the eyeball keypoints may include left eyeball keypoints and right eyeball keypoints. In the process of determining the distances between the center points of the candidate eyeball regions and the eyeball keypoints in the facial keypoints of the adjusted target head model, distances between the center points of the candidate eyeball regions and the left eyeball keypoints as well as the right eyeball keypoints may be respectively determined. In the candidate eyeball regions, the candidate eyeball region that shows a smallest distance to the left eyeball keypoints is determined as a left eyeball region, and the candidate eyeball region that shows a smallest distance to the right eyeball keypoints is determined as a right eyeball region. The left eyeball region and the right eyeball region may be determined according to similarities between the center points of the candidate eyeball regions and the left eyeball keypoints as well as the right eyeball keypoints. Since an eyeball in three-dimensional model modeling may be a plurality of concentric spherical shells, configured for representing components such as an iris, a pupil, a sclera, and a cornea forming the eyeball, the determined left eyeball region and right eyeball region may include a plurality of concentric spherical shells (also referred to as multilayer eyeball components). The eyeball region is determined in the foregoing manner because when the spherical similarity is less than the similarity threshold, or the center point of the feature region is excessively far from an eyeball space center with a highest confidence, the feature region is not considered as the eyeball region. An eye region and an eyeball position in the model can be more accurately determined based on eye features in the foregoing calculation manner, so that in some expression transformations involving the eyeball, better control over the movement of feature points can be achieved, allowing for a more natural representation of eye-related expressions in the target head model.

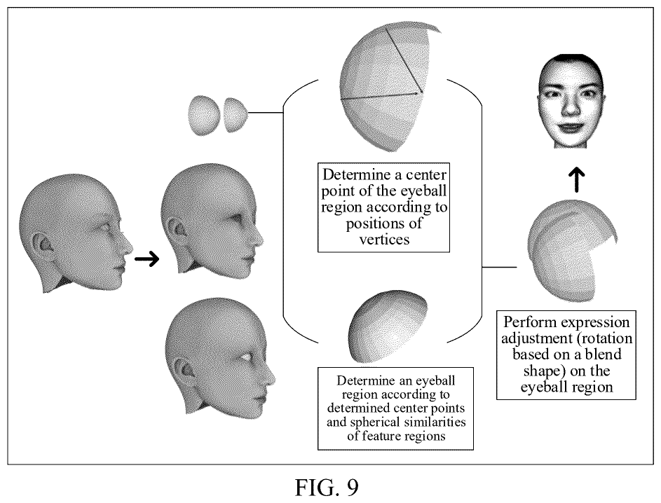

The linked feature region corresponding to the eyeball accessory region may be an eyeball region, for example, the eyeball accessory region may be adjusted following the adjustment of the eyeball region. After determining the eyeball region from the plurality of feature regions, the model processing device may further perform expression adjustment on the eyeball region. The expression adjustment of the eyeball region involves rotation of the eyeball. According to vertex deformation parameters of vertices in the eyeball region in the target head model, positions of the corresponding vertices in the adjusted target head model may be adjusted, for example, rotated based on the blend shape. FIG. 9 is a schematic diagram of localization and rotation of an eyeball region according to some embodiments. The model processing device may determine, in the target head model, a plurality of feature regions forming the target head model and determine the eyeball region from the plurality of feature regions; and in the process of determining the eyeball region from the plurality of feature regions, may determine the eyeball region (for example, determine the multilayer eyeball components forming the eyeball region) according to center points and spherical similarities of the determined feature regions. The center point of the eyeball region is a center point of the multilayer eyeball components, and is determined according to positions of vertices in the multilayer eyeball components. Since the multilayer eyeball components are concentric spherical shells, the center point of the eyeball region may also be determined according to positions of vertices in any eyeball component. The model processing device may perform expression adjustment on the eyeball region, for example, perform rotation based on the blend shape.

In some embodiments, after the eyeball region and the eyeball accessory region are determined from the plurality of feature regions, the linked feature region corresponding to the target feature region (for example, the eyeball accessory region) may be determined from the plurality of feature regions. If the target feature region belongs to the eyeball accessory region, a position relationship between the target feature region and the eyeball region in the plurality of feature regions is determined; and the linked feature region is determined from the eyeball region and the facial feature region according to the position relationship between the target feature region and the eyeball region. If a distance between the target feature region and the eyeball region is less than a distance threshold, the eyeball region is determined as the linked feature region; otherwise, the facial feature region is determined as the linked feature region. The eyeball accessory region is a feature region indicating an eyeball accessory. The eyeball accessory may include structural components related to the eyeball, such as eyeball contents, an eyelid, an eyelash, and an eyebrow. When determining the linked feature region from the eyeball region and the facial feature region according to the position relationship between the target feature region and the eyeball region, the model processing device may determine the linked feature region based on the distance between the target feature region and the eyeball region. If the distance between the target feature region and the eyeball region is less than the distance threshold, the eyeball region is determined as the linked feature region; otherwise, the facial feature region is determined as the linked feature region. The distance threshold may be set according to a requirement. For example, the eyeball region may be determined as a linked feature region corresponding to an eyeball accessory region indicating eyeball contents, and the facial feature region may be determined as a linked feature region corresponding to an eyeball accessory region indicating an eyelid, an eyeball accessory region indicating an eyelash, and an eyeball accessory region indicating an eyebrow.

In some embodiments, when determining the linked feature region from the eyeball region and the facial feature region according to the position relationship between the target feature region and the eyeball region, the model processing device may further determine type of eyeball accessory regions according to the position relationship between the target feature region (for example, the eyeball accessory region) and the eyeball region, and determine the linked feature region from the eyeball region and the facial feature region according to the types of the eyeball accessory regions. For example, among the eyeball accessory regions, the eyeball accessory region overlapping with the eyeball region may be determined as the eyeball accessory region indicating eyeball contents, and among the eyeball accessory regions, the eyeball accessory region located above the eyeball region and close to facial keypoints indicating an eyebrow in the facial keypoints may be determined as the eyeball accessory region indicating the eyebrow. In the process of determining the linked feature region from the eyeball region and the facial feature region according to the types of the eyeball accessory regions, the eyeball region may be determined as the linked feature region corresponding to the eyeball accessory region indicating the eyeball contents, and the facial feature region may be determined as the linked feature region corresponding to the eyeball accessory region indicating the eyelid, the eyeball accessory region indicating the eyelash, and the eyeball accessory region indicating the eyebrow.

In some embodiments, the model processing device may further determine an oral region from the plurality of feature regions, and further determine an oral accessory region. The oral accessory region is a feature region indicating an oral accessory zone, and the oral accessory may include structural components related to an oral cavity, such as upper and lower jaws, teeth, and a tongue. After determining the oral accessory region, the model processing device may determine a feature region indicating upper and lower jaws as the linked feature region corresponding to the oral accessory region, so that the oral accessory region may be adjusted following the adjustment of the feature region indicating the upper and lower jaws, for example, may be subjected to rigid adjustment following the adjustment of the feature region indicating the upper and lower jaws. In the oral accessory region, an oral accessory region indicating a tongue may also be correspondingly adjusted according to vertex deformation parameters of vertices in the oral accessory region indicating the tongue in the target head model.

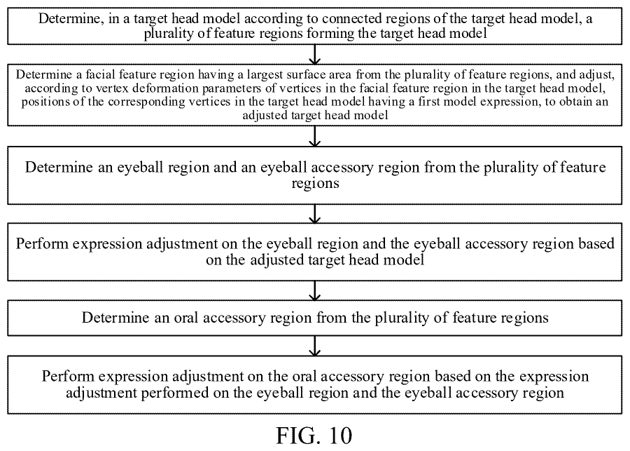

FIG. 10 is a schematic diagram of performing expression transfer on a target head model according to some embodiments. According to connected regions of the target head model, a plurality of feature regions forming the target head model are determined in the target head model. A facial feature region having a largest surface area is determined from the plurality of feature regions, and according to vertex deformation parameters of vertices in the facial feature region in the target head model, positions of the corresponding vertices in the target head model having the first model expression are adjusted, to obtain an adjusted target head model. An eyeball region and an eyeball accessory region are determined from the plurality of feature regions. Expression adjustment is performed on the eyeball region and the eyeball accessory region based on the adjusted target head model. For example, an eyeball accessory region indicating an eyelash is adjusted following the adjustment of the facial feature region. An oral accessory region is determined from the plurality of feature regions. Expression adjustment is performed on the oral accessory region based on the expression adjustment performed on the eyeball region and the eyeball accessory region. For example, an oral accessory region indicating upper and lower jaws and an oral accessory region indicating teeth are adjusted following the adjustment of a feature region indicating the upper and lower jaws.

In some embodiments, if the target feature region belongs to an eyelid region, the first model expression in the source head model includes an expression indicating that the source head model is in an open-eye state, and the second model expression in the source head model includes an expression indicating that the source head model is in a closed-eye state, that the model processing device performs expression adjustment on the target feature region based on the adjustment rule for the target feature region in the plurality of feature regions may include: determining a lower eyelid boundary and an upper eyelid boundary in the eyelid region in the adjusted target head model; and performing collision deformation on the eyelid region according to a size parameter and a position of the eyeball region in the plurality of feature regions and based on a Laplace's equation, to obtain a deformed eyelid region. The process enables the upper eyelid boundary to coincide with the lower eyelid boundary in a deformed eyelid region as closely as possible. Since the eyes include a left eye and a right eye, the adjustment of the eyelid region in the foregoing process may be adjustment of an eyelid region corresponding to the left eye, adjustment of an eyelid region corresponding to the right eye, or adjustment of eyelid regions corresponding to both eyes. For example, when the second model expression in the source head model indicates that the source head model is in a closed-eye state of the left eye, the eyelid region corresponding to the left eye is correspondingly adjusted; when the second model expression in the source head model indicates that the source head model is in a closed-eye state of the right eye, the eyelid region corresponding to the right eye is correspondingly adjusted; and when the second model expression in the source head model indicates that the source head model is in a closed-eye state of both eyes, the eyelid regions corresponding to both eyes are correspondingly adjusted.

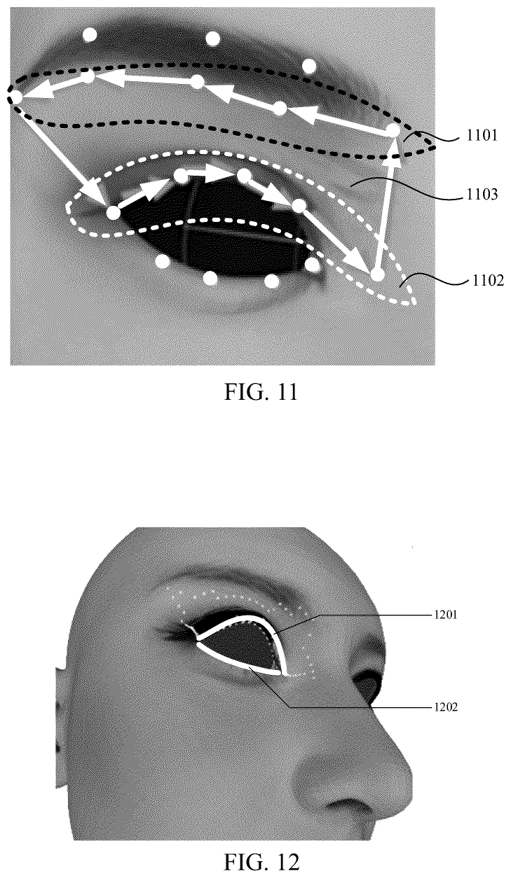

In some embodiments, the eyelid region may be determined from the plurality of feature regions, or may be determined according to distribution positions of the facial keypoints in the target head model. During implementation, facial keypoints indicating a lower part of the eyebrow and an upper part of the eye in the target head model may be connected with a shortest distance, and the connected region is determined as the eyelid region. FIG. 11 is a schematic diagram of determining an eyelid region according to some embodiments. Facial keypoints indicating the lower part of the eyebrow may be indicated by label 1101, facial keypoints indicating the upper part of the eye may be indicated by label 1102, and the determined eyelid region may be indicated by label 1103. FIG. 12 is a schematic diagram of a lower eyelid boundary and an upper eyelid boundary according to some embodiments. The upper eyelid boundary may be indicated by label 1201, and the lower eyelid boundary may be indicated by label 1202.

In the process of performing collision deformation on the eyelid region according to a size parameter and a position of the eyeball region in the plurality of feature regions and based on a Laplace's equation, to obtain a deformed eyelid region, the model processing device uses the size parameter and the position of the eyeball region as newly added constraints in the Laplace's equation, and solves the Laplace's equation, allowing for resolving the collision between the eyelid vertices and the eyeball while maintaining the consistency of mesh surface normal vectors and original vertex positions, thereby reducing the possibility of eyeball penetration caused during the collision deformation on the eyelid region. During the collision deformation on the eyelid region, boundary points other than the upper eyelid boundary region may remain stationary, and the remaining vertices are deformed to enable the upper eyelid boundary to coincide with the lower eyelid boundary. By adding the constraints to the Laplace's equation, this process reduces the possibility of eyeball penetration caused in during the collision deformation on the eyelid region, and improves a transfer effect of the second model expression indicating the closed-eye state to the target head model, allowing the target head model to achieve a better “closed-eye” effect.

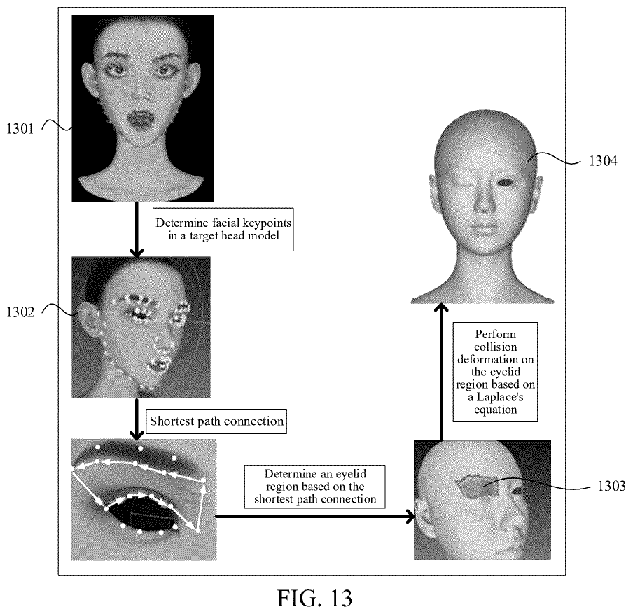

FIG. 13 is a schematic diagram of adjusting an eyelid region according to some embodiments. Reference facial keypoints in the two-dimensional face image may be indicated by label 1301. The model processing device may determine the facial keypoints in the target head model based on the reference facial keypoints in the two-dimensional face image, and a distribution status of the facial keypoints is indicated by label 1302. The eyelid region may be determined from the target head model based on a shortest distance connection (also referred to as a shortest path connection). The determined eyelid region may be indicated by label 1303. After a lower eyelid boundary and an upper eyelid boundary are determined, collision deformation may be performed on the eyelid region based on the Laplace's equation, to obtain a deformed eyelid region. The upper eyelid boundary coincides with the lower eyelid boundary in the deformed eyelid region, and a corresponding adjustment effect may be indicated by label 1304.

In some embodiments, the target head model may be obtained by performing model simplification on a head model region of an interaction model, and a quantity of vertices in the target head model is less than a quantity of vertices in the head model region of the interaction model. After obtaining the target head model having the second model expression, the model processing device may further: determine, according to positions of texture feature points in the head model region of the interaction model, a mesh region corresponding to the texture feature points in the target head model, and determine a position mapping of the texture feature points in the head model region of the interaction model in the corresponding mesh region in the target head model; determine deformed positions of the texture feature points in the head model region of the interaction model according to the position mapping and positions of vertices included in the corresponding mesh region; and perform deformation on the texture feature points in the head model region of the interaction model according to the deformed positions of the texture feature points in the head model region of the interaction model, to obtain an interaction model having the second model expression. The interaction model may be a model configured to interact with an object, for example, may be a model obtained by face sculpting by a user, a model in a film and television work, or a model in a game scene. In some embodiments, the interaction model may be a human body model, a head model, or the like. The texture feature points may be texture coordinate points corresponding to the vertices. In some embodiments, the positions of the texture feature points may be positions indicated by texture coordinates of the texture coordinate points, and the positions of the vertices included in the mesh region may be positions indicated by texture coordinates of the vertices. The position mapping of the texture feature points in the head model region of the interaction model in the corresponding mesh region in the target head model may be centroid coordinates of the texture feature points in the corresponding mesh region, and the mesh region is a triangle.

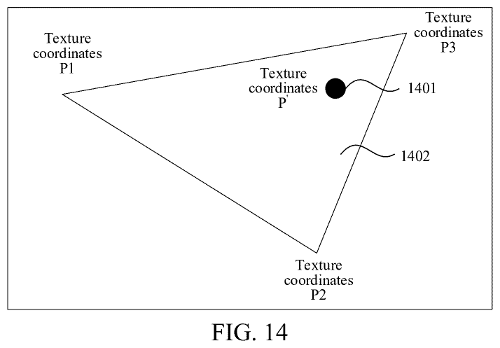

In a feasible implementation, in the process of performing model simplification on the head model region of the interaction model, the model processing device may perform texture unwrapping and decomposition on the head model region of the interaction model, to further perform model simplification by reducing vertices. A quantity of vertices that may be retained for the model simplification may be set according to a requirement. For example, it may be set that 10000 vertices are retained. During the model simplification, boundary points of a head model region of the interaction model may be retained. FIG. 14 is a schematic diagram of a texture coordinate relationship according to some embodiments. A texture feature point in the head model region of the interaction model may be indicated by label 1401. Texture coordinates of the texture feature point may be represented as P′, and a corresponding mesh region may be indicated by label 1402. Texture coordinates of three vertices may be respectively represented as P1, P2, and P3. If centroid coordinates of the texture feature point in the corresponding mesh region are represented as [w₁ w₂ w₃], a deformed position of the texture feature point may be expressed by the following formula 11:

P′=w₁P₁+w₂P₂+w₃P₃ (11)

Since the target head model is obtained by performing model simplification on the head model region of the interaction model, it may be considered that the head model of the interaction model is a high-poly model, and the target head model is a low-poly model. The process is essentially a high-to-low poly expression transfer process. Deformation of the low-poly target head model is transferred to the head model region of the high-poly interaction model, so that the second model expression can be implemented in the head model region of the interaction model. The deformation transfer is performed in the foregoing manner without loss of precision. A generated blend shape (for example, a blend shape corresponding to the second model expression) does not may use additional smoothing, and the high-poly model can achieve a higher-precision blend shape, resulting in a better effect of the second model expression on the high-poly model.

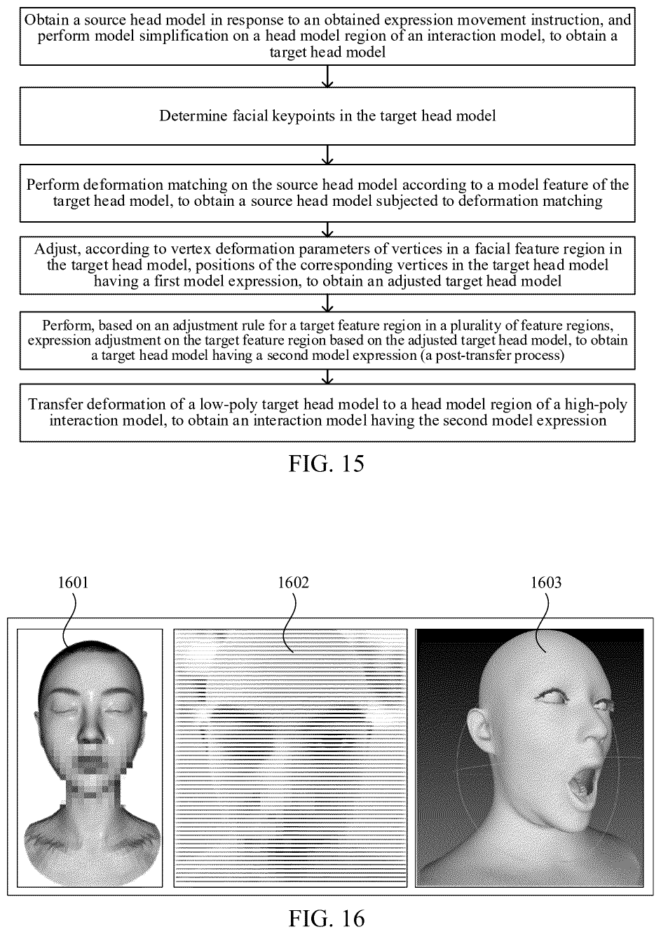

FIG. 15 is a schematic diagram of performing expression transfer on an interaction model according to some embodiments. A model processing device may obtain a source head model in response to an obtained expression movement instruction, and perform model simplification on a head model region of the interaction model, to obtain a target head model. The model processing device determines facial keypoints in the target head model. The model processing device performs deformation matching on the source head model according to a model feature of the target head model, to obtain a source head model subjected to deformation matching. The model feature of the target head model may include positions of the facial keypoints in the target head model. The model processing device may determine a deformation parameter according to the source head model subjected to deformation matching and a deformation relationship from a first model expression to a second model expression in the source head model, and perform expression transfer on the target head model according to the deformation parameter, to obtain a target head model having the second model expression. In the process of performing expression transfer related to the target head model according to the deformation parameter, to obtain the target head model having the second model expression, positions of the corresponding vertices in the target head model having the first model expression may be adjusted according to the vertex deformation parameters of the vertices in the facial feature region in the target head model, to obtain an adjusted target head model. Based on an adjustment rule for a target feature region in a plurality of feature regions, expression adjustment is performed on the target feature region based on the adjusted target head model, to obtain the target head model having the second model expression. The process may be referred to as a post-transfer process. The model processing device may determine a mesh region corresponding to texture feature points in the target head model according to positions of the texture feature points in the head model region of the interaction model, and determine a position mapping of the texture feature points in the head model region of the interaction model in the corresponding mesh region in the target head model; determine deformed positions of the texture feature points in the head model region of the interaction model according to the position mapping and positions of vertices included in the corresponding mesh region; and perform deformation on the texture feature points in the head model region of the interaction model according to the deformed positions of the texture feature points in the head model region of the interaction model, to obtain an interaction model having the second model expression.

FIG. 16 is a schematic diagram of an effect of expression transfer according to some embodiments. It can be known from 1601 and 1602 that the target head model can achieve a good “closed-eye” effect based on the model processing method provided in this solution. Since this method allows for deformation transfer from a low-poly model to a high-poly model without loss of precision, a generated blend shape (for example, a blend shape corresponding to the second model expression) does not may use additional smoothing, and the high-poly model can achieve a higher-precision blend shape, resulting in a better effect of the second model expression on the high-mode model. An exemplary effect of a second model expression achieved on the high-poly model may be indicated by label 1603.

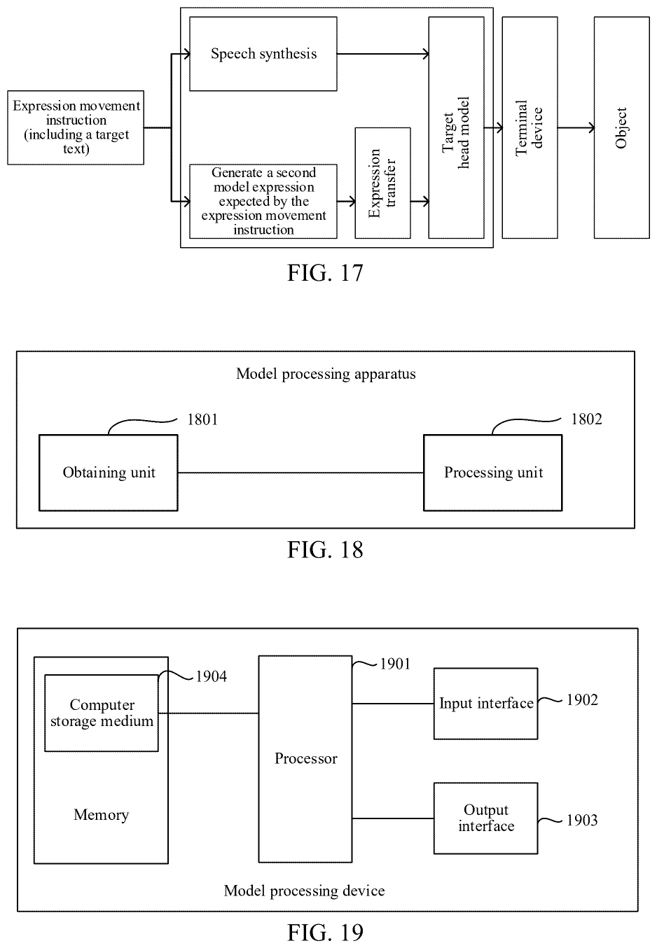

In some embodiments, the model processing method may be applied to an object interaction scenario, for example, may be configured for generating a model having some model expressions to implement object interaction. For example, in a case that the expression movement instruction includes a target text for instructing to generate the second model expression, the model processing device may perform speech synthesis based on the target text, to obtain target speech corresponding to the target text; and output the target head model having the second model expression and the target speech after obtaining the target head model having the second model expression, to perform interaction based on the target head model. The speech synthesis may be performed by a text-to-speech (TTS) module. The target text may be recorded by an object. The target head model may be set by the object, for example, may be a head model of a game character set by the object in a game scene. The target head model and the target speech may be output to a terminal device of the object, to implement interaction with the object. FIG. 17 is a schematic diagram of an application scenario according to some embodiments. In a case of receiving the expression movement instruction including the target text configured for instructing to generate the second model expression, the model processing device may perform speech synthesis based on the target text, to obtain the target speech corresponding to the target text; obtain the source head model, and performing instruction analysis on the expression movement instruction to generate, for the source head model, the second model expression expected by the expression movement instruction; transfer the second model expression to the target head model, to obtain the target head model having the second model expression; and output the target head model having the second model expression and the target speech, to perform interaction based on the target head model. In some embodiments, display of an expression of the source head model may be instructed by speech, and the expression may be transferred to the target head model. This can more conveniently achieve expression control over a designed target head model and satisfy requirements of automated and intelligent expression control of a head model.

In some embodiments, in the process of obtaining the target head model having the second model expression by performing expression transfer according to the deformation parameter, positions of corresponding vertices in the target head model having the first model expression may be adjusted first according to the vertex deformation parameters of the vertices in the facial feature region in the target head model, to obtain the adjusted target head model. Based on an adjustment rule for a target feature region in the plurality of feature regions, expression adjustment is further performed on the target feature region based on the adjusted target head model, to obtain the target head model having the second model expression. Deformation transfer of the eyeball region, the eyeball accessory region, the oral accessory region, and the eyelid region in the target head model may be performed, to improve an expression transfer effect of the corresponding regions. The high-poly head model may be simplified to obtain the low-poly target head model, so that expression transfer may be performed in the low-poly target head model, and after the target head model having the second model expression is obtained, corresponding deformation may be transferred from the low-poly model to the high-poly model, to complete transfer of the second model expression in the high-poly head model, thereby accelerating an expression transfer process of the high-poly model.

Based on the related embodiments of the foregoing model processing method, some embodiments provide a model processing apparatus. FIG. 18 is a schematic structural diagram of a model processing apparatus according to some embodiments. The model processing apparatus may include an obtaining unit 1801 and a processing unit 1802. The model processing apparatus shown in FIG. 18 may be configured to perform the following operations.

The obtaining unit 1801 is configured to obtain a source head model in response to an obtained expression movement instruction. The source head model is configured with neutral feature data, and a plurality of pieces of expression feature data relative to the neutral feature data. The processing unit 1802 is configured to perform deformation matching on the source head model according to a model feature of a target head model, to obtain a source head model subjected to deformation matching. The processing unit 1802 is further configured to determine a deformation parameter according to the source head model subjected to deformation matching and a deformation relationship from a first model expression to a second model expression in the source head model. The first model expression in the source head model is determined according to the neutral feature data of the source head model, and the second model expression in the source head model is determined according to expression feature data indicated by the expression movement instruction in the plurality of pieces of expression feature data. The processing unit 1802 is further configured to perform expression transfer on the target head model according to the deformation parameter, to obtain a target head model having the second model expression.

In some embodiments, in the process of performing the deformation matching on the source head model according to the model feature of the target head model, to obtain the source head model subjected to deformation matching, the processing unit 1802 performs the following operations:
determining a matching relationship between feature points in the source head model and feature points in the target head model according to positions of the feature points in the source head model and positions of the feature points in the target head model, the feature points including: one or two of vertices and facial keypoints in the corresponding models; and performing, according to the matching relationship and using the positions of the feature points in the target head model as reference positions, position adjustment on vertices forming the source head model, to obtain the source head model subjected to deformation matching, distances between the positions of the feature points in the source head model subjected to deformation matching and the corresponding reference positions determined according to the matching relationship satisfying a proximity condition.

In some embodiments, in the process of determining the deformation parameter according to the source head model subjected to deformation matching and the deformation relationship from the first model expression to the second model expression in the source head model, the processing unit 1802 performs the following operations:

determining, according to positions of feature points in the source head model subjected to deformation matching and positions of the corresponding feature points in the source head model, a deformation relationship between the source head model and the source head model subjected to deformation matching, the feature points including: one or two of vertices and facial keypoints in the corresponding models; and determining the deformation parameter according to the deformation relationship between the source head model and the source head model subjected to deformation matching, and the deformation relationship from the first model expression to the second model expression in the source head model.

In some embodiments, in the process of determining the deformation parameter according to the deformation relationship between the source head model and the source head model subjected to deformation matching, and the deformation relationship from the first model expression to the second model expression in the source head model, the processing unit 1802 performs the following operations:

determining, according to the deformation relationship between the source head model and the source head model subjected to deformation matching, a first vertex deformation relationship between reference vertices in the source head model and the corresponding vertices in the source head model subjected to deformation matching; determining, according to the deformation relationship from the first model expression to the second model expression in the source head model, a second vertex deformation relationship between reference vertices in the source head model having the first model expression and the corresponding vertices in the source head model having the second model expression; and determining vertex deformation parameters of target vertices corresponding to the reference vertices in the target head model according to the first vertex deformation relationship of the reference vertices and the second vertex deformation relationship of the reference vertices.

In some embodiments, in the process of performing expression transfer on the target head model according to the deformation parameter, to obtain the target head model having the second model expression, the processing unit 1802 performs the following operations:
determining, in the target head model, a plurality of feature regions forming the target head model; adjusting, according to vertex deformation parameters of vertices in a facial feature region in the target head model, positions of the corresponding vertices in the target head model having the first model expression, to obtain an adjusted target head model, the facial feature region being a feature region having a largest surface area in the plurality of feature regions; and performing, based on an adjustment rule for a target feature region in the plurality of feature regions, expression adjustment on the target feature region based on the adjusted target head model, to obtain the target head model having the second model expression.

In some embodiments, in the process of performing, based on the adjustment rule for the target feature region in the plurality of feature regions, expression adjustment on the target feature region, the processing unit 1802 performs the following operations:
determining a linked feature region corresponding to the target feature region from the plurality of feature regions; and performing follow-up adjustment on the target feature region according to adjustment of the linked feature region based on an instruction of the adjustment rule for the target feature region.

In some embodiments, in the process of performing follow-up adjustment on the target feature region according to the adjustment of the linked feature region based on the instruction of the adjustment rule for the target feature region, the processing unit 1802 performs the following operations:
if an overlapping area between the target feature region and the linked feature region is less than an area threshold, adjusting positions of vertices in the target feature region according to a rigid adjustment method, following the adjustment of positions of vertices in the linked feature region; or if the overlapping area between the target feature region and the linked feature region is greater than or equal to the area threshold, adjusting the positions of the vertices in the target feature region according to a Laplace's method, following the adjustment of the positions of the vertices in the linked feature region.

In some embodiments, in the process of determining the linked feature region corresponding to the target feature region from the plurality of feature regions, the processing unit 1802 performs the following operations:
determining a position relationship between the target feature region and an eyeball region in the plurality of feature regions if the target feature region belongs to an eyeball accessory region; and determining the linked feature region from the eyeball region and the facial feature region according to the position relationship between the target feature region and the eyeball region, if a distance between the target feature region and the eyeball region is less than a distance threshold, the eyeball region being determined as the linked feature region; otherwise, the facial feature region being determined as the linked feature region.

In some embodiments, the plurality of feature regions include the eyeball region; and in the process of determining the eyeball region from the plurality of feature regions, the processing unit 1802 performs the following operations:
determining center points and spherical similarities of the feature regions, the spherical similarity of a feature region being configured for indicating a degree to which the corresponding feature region resembles a sphere; and determining the eyeball region from the plurality of feature regions according to distances between the center points of the feature regions and eyeball keypoints in facial keypoints of the adjusted target head model and degrees of resembling a sphere indicated by the spherical similarities of the feature regions.

In some embodiments, the spherical similarity of a feature region is negatively correlated with a degree to which the corresponding feature region resembles a sphere; and
in the process of determining the eyeball region from the plurality of feature regions according to distances between the center points of the feature regions and eyeball keypoints in facial keypoints of the adjusted target head model and degrees of resembling a sphere indicated by the spherical similarities of the feature regions, the processing unit 1802 performs the following operations:
determining the feature regions with the spherical similarity less than a similarity threshold in the feature regions as candidate eyeball regions; determining the distance between the center points of the candidate eyeball regions and the eyeball keypoints in the facial keypoints of the adjusted target head model; and determining the candidate eyeball region indicated by a smallest distance in the candidate eyeball regions as the eyeball region.

In some embodiments, in the process of determining the center points and the spherical similarities of the feature regions, the processing unit 1802 performs the following operations:
determining, for a currently traversed feature region in the feature regions, a center point of the currently traversed feature region according to positions of vertices in the currently traversed feature region; determining, according to the positions of the vertices in the currently traversed feature region and a position of the center point, radii of distances from the vertices in the currently traversed feature region to the center point, and an average radius corresponding to the vertices in the currently traversed feature region; and determining the spherical similarity of the currently traversed feature region according to differences between the radii of distances from the vertices in the currently traversed feature region to the center points and the average radius.

In some embodiments, the target feature region belongs to an eyelid region; the first model expression in the source head model includes an expression indicating that the source head model is in an open-eye state, and the second model expression in the source head model includes an expression indicating that the source head model is in a closed-eye state; and
in the process of performing, based on the adjustment rule for the target feature region in the plurality of feature regions, expression adjustment on the target feature region, the processing unit 1802 performs the following operations:
determining a lower eyelid boundary and an upper eyelid boundary in the eyelid region in the adjusted target head model; and performing collision deformation on the eyelid region according to a size parameter and a position of the eyeball region in the plurality of feature regions and based on a Laplace's equation, to obtain a deformed eyelid region.

In some embodiments, in the process of determining, in the target head model, the plurality of feature regions forming the target head model, the processing unit 1802 performs the following operations:
determining connected regions of the target head model in the target head model, and determining coinciding boundaries between the connected regions; and performing region merging on the connected regions according to determined lengths of the coinciding boundaries, and determining a plurality of connected regions obtained through the region merging as the plurality of feature regions.

In some embodiments, the target head model is obtained by performing model simplification on a head model region of an interaction model, and a quantity of vertices in the target head model is less than a quantity of vertices in the head model region of the interaction model; and the processing unit 1802 is further configured to:
determine, according to positions of texture feature points in the head model region of the interaction model, a mesh region corresponding to the texture feature points in the target head model, and determine a position mapping of the texture feature points in the head model region of the interaction model in the corresponding mesh region in the target head model; determine deformed positions of the texture feature points in the head model region of the interaction model according to the position mapping and positions of vertices included in the corresponding mesh region; and perform deformation on the texture feature points in the head model region of the interaction model according to the deformed positions of the texture feature points in the head model region of the interaction model, to obtain an interaction model having the second model expression.

In some embodiments, the expression movement instruction includes a target text configured for instructing to generate the second model expression; and the processing unit 1802 is further configured to:
perform speech synthesis based on the target text, to obtain target speech corresponding to the target text; and output the target head model having the second model expression and the target speech after obtaining the target head model having the second model expression, to perform interaction based on the target head model.

According to some embodiments, the operations involved in the model processing methods shown in FIG. 2, FIG. 3, and FIG. 7 may be performed by the units in the model processing apparatus shown in FIG. 18. For example, operation 201 shown in FIG. 2 may be performed by the obtaining unit 1801 in the model processing apparatus shown in FIG. 18, and operation 202 to operation 204 shown in FIG. 2 may be performed by the processing unit 1802 in the model processing apparatus shown in FIG. 18. For another example, operation 301 shown in FIG. 3 may be performed by the obtaining unit 1801 in the model processing apparatus shown in FIG. 18, and operation 302 to operation 305 shown in FIG. 3 may be performed by the processing unit 1802 in the model processing apparatus shown in FIG. 18. For another example, operation 701 shown in FIG. 7 may be performed by the obtaining unit 1801 in the model processing apparatus shown in FIG. 18, and operation 702 to operation 706 shown in FIG. 7 may be performed by the processing unit 1802 in the model processing apparatus shown in FIG. 18.

According to some embodiments, throughout the disclosure, each unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. In actual applications, these functions may also be realized cooperatively by the other units, and may be realized cooperatively by multiple units.

A person skilled in the art would understand that these “units” could be implemented by hardware logic, a processor or processors executing computer software code, or a combination of both. The “units” may also be implemented in software stored in a memory of a computer or a non-transitory computer-readable medium, where the instructions of each unit are executable by a processor to thereby cause the processor to perform the respective operations of the corresponding unit.

According to some embodiments, the model processing apparatus shown in FIG. 18 may be constructed and the model processing method in some embodiments may be implemented by running a computer program (including program code) that can perform the operations related to the corresponding methods shown in FIG. 2, FIG. 3, and FIG. 7 on a computing device, for example, a computer, including a processing element and a storage element such as a central processing unit (CPU), a random access memory (RAM), a read-only memory (ROM), and the like. The computer program may be stored in, for example, a computer-readable storage medium, loaded in the computing device through the computer-readable storage medium, and run in the computing device.

In some embodiments, after the expression movement instruction is obtained, deformation matching may be performed from the source head model to the target head model, so that the source head model subjected to deformation matching approximates the target head model. The deformation parameter may be determined according to the source head model subjected to deformation matching and the deformation relationship from the first model expression in the source head model to the second model expression indicated by the expression movement instruction, and expression transfer may be performed on the target head model according to the deformation parameter, to obtain the target head model having the second model expression. The second model expression can be automatically transferred from the source head model to the target head model. Expression transformation on some target head models (for example, newly designed head models) can be implemented based on expression transformation of some source head models (for example, standard models). The second model expression can be automatically generated for the target head model, and the second model expression in the source head model can be reused in different head models, further improving the efficiency of generating model expressions by different head models, and reducing human resource consumption.

Based on the related embodiments of the foregoing model processing method and the related embodiments of the model processing apparatus, some embodiments further provide a model processing device. FIG. 19 is a schematic structural diagram of a model processing device according to some embodiments. The model processing device shown in FIG. 19 includes at least a processor 1901, an input interface 1902, an output interface 1903, and a computer storage medium 1904. The processor 1901, the input interface 1902, the output interface 1903, and the computer storage medium 1904 may be connected through a bus or in another manner.

The computer storage medium 1904 may be stored in a memory of the model processing device. The computer storage medium 1904 is configured to store a computer program. The computer program includes program instructions. The processor 1901 is configured to execute the program instructions stored in the computer storage medium 1904. The processor 1901 (or referred to as a central processing unit (CPU)) is a computing core and a control core of the model processing device, is configured to implement one or more instructions, and may be configured to load and execute the one or more instructions to implement procedures of corresponding functions of the foregoing model processing method.

Some embodiments further provide a computer storage medium (memory). The computer storage medium is a memory device in a model processing device, and is configured to store a program and data. The computer storage medium herein may include a built-in storage medium in a terminal, and certainly may also include an expanded storage medium supported by the terminal. The computer storage medium provides a storage space, and the storage space stores an operating system of the terminal. The storage space further stores one or more instructions to be loaded and executed by the processor 1901. The instructions may be one or more computer programs (including program code). The computer storage medium herein may be a high-speed random access memory (RAM), or may be a non-volatile memory, for example, at least one magnetic disk memory. In some embodiments, the computer storage medium may be at least one computer storage medium located far from the foregoing processor.

In some embodiments, the processor 1901 may load and execute the one or more instructions stored in the computer storage medium to implement corresponding operations in the method in the model processing method embodiments shown in FIG. 2, FIG. 3, and FIG. 7. During implementation, the processor 1901 loads the one or more instructions in the computer storage medium and perform the following operations:

obtaining a source head model in response to an obtained expression movement instruction, the source head model being configured with neutral feature data, and a plurality of pieces of expression feature data relative to the neutral feature data; performing deformation matching on the source head model according to a model feature of a target head model, to obtain a source head model subjected to deformation matching; determining a deformation parameter according to the source head model subjected to deformation matching and a deformation relationship from a first model expression to a second model expression in the source head model, the first model expression in the source head model being determined according to the neutral feature data of the source head model, and the second model expression in the source head model being determined according to expression feature data indicated by the expression movement instruction in the plurality of pieces of expression feature data; and performing expression transfer on the target head model according to the deformation parameter, to obtain a target head model having the second model expression.

In some embodiments, in the process of performing the deformation matching on the source head model according to the model feature of the target head model, to obtain the source head model subjected to deformation matching, the processor 1901 performs the following operations:
determining a matching relationship between feature points in the source head model and feature points in the target head model according to positions of the feature points in the source head model and positions of the feature points in the target head model, the feature points including: one or two of vertices and facial keypoints in the corresponding models; and performing, according to the matching relationship and using the positions of the feature points in the target head model as reference positions, position adjustment on vertices forming the source head model, to obtain the source head model subjected to deformation matching, distances between the positions of the feature points in the source head model subjected to deformation matching and the corresponding reference positions determined according to the matching relationship satisfying a proximity condition.

In some embodiments, in the process of determining the deformation parameter according to the source head model subjected to deformation matching and the deformation relationship from the first model expression to the second model expression in the source head model, the processor 1901 performs the following operations:
determining, according to positions of feature points in the source head model subjected to deformation matching and positions of the corresponding feature points in the source head model, a deformation relationship between the source head model and the source head model subjected to deformation matching, the feature points including: one or two of vertices and facial keypoints in the corresponding models; and determining the deformation parameter according to the deformation relationship between the source head model and the source head model subjected to deformation matching, and the deformation relationship from the first model expression to the second model expression in the source head model.

In some embodiments, in the process of determining the deformation parameter according to the deformation relationship between the source head model and the source head model subjected to deformation matching, and the deformation relationship from the first model expression to the second model expression in the source head model, the processor 1901 performs the following operations:
determining, according to the deformation relationship between the source head model and the source head model subjected to deformation matching, a first vertex deformation relationship between reference vertices in the source head model and the corresponding vertices in the source head model subjected to deformation matching; determining, according to the deformation relationship from the first model expression to the second model expression in the source head model, a second vertex deformation relationship between reference vertices in the source head model having the first model expression and the corresponding vertices in the source head model having the second model expression; and determining vertex deformation parameters of target vertices corresponding to the reference vertices in the target head model according to the first vertex deformation relationship of the reference vertices and the second vertex deformation relationship of the reference vertices.

In some embodiments, in the process of performing expression transfer on the target head model according to the deformation parameter, to obtain the target head model having the second model expression, the processor 1901 performs the following operations:
determining, in the target head model, a plurality of feature regions forming the target head model; adjusting, according to vertex deformation parameters of vertices in a facial feature region in the target head model, positions of the corresponding vertices in the target head model having the first model expression, to obtain an adjusted target head model, the facial feature region being a feature region having a largest surface area in the plurality of feature regions; and performing, based on an adjustment rule for a target feature region in the plurality of feature regions, expression adjustment on the target feature region based on the adjusted target head model, to obtain the target head model having the second model expression.

In some embodiments, in the process of performing, based on the adjustment rule for the target feature region in the plurality of feature regions, expression adjustment on the target feature region, the processor 1901 performs the following operations:
determining a linked feature region corresponding to the target feature region from the plurality of feature regions; and performing follow-up adjustment on the target feature region according to adjustment of the linked feature region based on an instruction of the adjustment rule for the target feature region.

In some embodiments, in the process of performing follow-up adjustment on the target feature region according to the adjustment of the linked feature region based on the instruction of the adjustment rule for the target feature region, the processor 1901 performs the following operations:
if an overlapping area between the target feature region and the linked feature region is less than an area threshold, adjusting positions of vertices in the target feature region according to a rigid adjustment method, following the adjustment of positions of vertices in the linked feature region; or if the overlapping area between the target feature region and the linked feature region is greater than or equal to the area threshold, adjusting the positions of the vertices in the target feature region according to a Laplace's method, following the adjustment of the positions of the vertices in the linked feature region.

In some embodiments, in the process of determining the linked feature region corresponding to the target feature region from the plurality of feature regions, the processor 1901 performs the following operations:
determining a position relationship between the target feature region and an eyeball region in the plurality of feature regions if the target feature region belongs to an eyeball accessory region; and determining the linked feature region from the eyeball region and the facial feature region according to the position relationship between the target feature region and the eyeball region, if a distance between the target feature region and the eyeball region is less than a distance threshold, the eyeball region being determined as the linked feature region; otherwise, the facial feature region being determined as the linked feature region.

In some embodiments, the plurality of feature regions include the eyeball region; and in the process of determining the eyeball region from the plurality of feature regions, the processor 1901 performs the following operations:
determining center points and spherical similarities of the feature regions, the spherical similarity of a feature region being configured for indicating a degree to which the corresponding feature region resembles a sphere; and determining the eyeball region from the plurality of feature regions according to distances between the center points of the feature regions and eyeball keypoints in facial keypoints of the adjusted target head model and degrees of resembling a sphere indicated by the spherical similarities of the feature regions.

In some embodiments, the spherical similarity of a feature region is negatively correlated with a degree to which the corresponding feature region resembles a sphere; and in the process of determining the eyeball region from the plurality of feature regions according to distances between the center points of the feature regions and eyeball keypoints in facial keypoints of the adjusted target head model and degrees of resembling a sphere indicated by the spherical similarities of the feature regions, the processor 1901 performs the following operations:
determining the feature regions with the spherical similarity less than a similarity threshold in the feature regions as candidate eyeball regions; determining the distance between the center points of the candidate eyeball regions and the eyeball keypoints in the facial keypoints of the adjusted target head model; and determining the candidate eyeball region indicated by a smallest distance in the candidate eyeball regions as the eyeball region.

In some embodiments, in the process of determining the center points and the spherical similarities of the feature regions, the processor 1901 performs the following operations:
determining, for a currently traversed feature region in the feature regions, a center point of the currently traversed feature region according to a positions of vertices in the currently traversed feature region; determining, according to the positions of the vertices in the currently traversed feature region and a position of the center point, radii of distances from the vertices in the currently traversed feature region to the center point, and an average radius corresponding to the vertices in the currently traversed feature region; and determining the spherical similarity of the currently traversed feature region according to differences between the radii of distances from the vertices in the currently traversed feature region to the center points and the average radius.

In some embodiments, the target feature region belongs to an eyelid region; the first model expression in the source head model includes an expression indicating that the source head model is in an open-eye state, and the second model expression in the source head model includes an expression indicating that the source head model is in a closed-eye state; and in the process of performing, based on the adjustment rule for the target feature region in the plurality of feature regions, expression adjustment on the target feature region, the processor 1901 performs the following operations:
determining a lower eyelid boundary and an upper eyelid boundary in the eyelid region in the adjusted target head model; and performing collision deformation on the eyelid region according to a size parameter and a position of the eyeball region in the plurality of feature regions and based on a Laplace's equation, to obtain a deformed eyelid region.

In some embodiments, in the process of determining, in the target head model, the plurality of feature regions forming the target head model, the processor 1901 performs the following operations:
determining connected regions of the target head model in the target head model, and determining a coinciding boundaries between the connected regions; and performing region merging on the connected regions according to determined lengths of the coinciding boundaries, and determining a plurality of connected regions obtained through the region merging as the plurality of feature regions.

In some embodiments, the target head model is obtained by performing model simplification on a head model region of an interaction model, and a quantity of vertices in the target head model is less than a quantity of vertices in the head model region of the interaction model; and the processor 1901 is further configured to:
determine, according to positions of texture feature points in the head model region of the interaction model, a mesh region corresponding to the texture feature points in the target head model, and determine a position mapping of the texture feature points in the head model region of the interaction model in the corresponding mesh region in the target head model; determine deformed positions of the texture feature points in the head model region of the interaction model according to the position mapping and positions of vertices included in the corresponding mesh region; and perform deformation on the texture feature points in the head model region of the interaction model according to the deformed positions of the texture feature points in the head model region of the interaction model, to obtain an interaction model having the second model expression.

In some embodiments, the expression movement instruction includes a target text configured for instructing to generate the second model expression; and the processor 1901 is further configured to:
perform speech synthesis based on the target text, to obtain target speech corresponding to the target text; and output the target head model having the second model expression and the target speech after obtaining the target head model having the second model expression, to perform interaction based on the target head model.

Some embodiments provide a computer program product. The computer program product includes a computer program, the computer program being stored in a computer storage medium. A processor of a model processing device reads the computer program from the computer storage medium, and the processor executes the computer program, to cause the model processing device to perform some embodiments shown in FIG. 2, FIG. 3, and FIG. 7. The computer storage medium may include: a magnetic disk, an optical disc, a read-only memory (ROM), a random access memory (RAM), or the like.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A model processing method, comprising:
obtaining a first source head model in response to an obtained expression movement instruction, the first source head model comprising neutral feature data, and a plurality of pieces of expression feature data relative to the neutral feature data;
performing deformation matching on the first source head model according to a first model feature of a first target head model, to obtain a second source head model subjected to deformation matching;
determining a deformation parameter according to a first deformation relationship between the first source head model and the second source head model and a second deformation relationship from a first model expression to a second model expression in the first source head model, the first model expression being determined according to the neutral feature data of the first source head model, and the second model expression being determined according to expression feature data indicated by the expression movement instruction in the plurality of pieces of expression feature data; and
performing expression transfer on the first target head model according to the deformation parameter, to obtain a second target head model having the second model expression.

2. The model processing method according to claim 1, wherein the performing the deformation matching comprises:
determining a matching relationship between a first plurality of feature points in the first source head model and a second plurality of feature points in the first target head model according to a first plurality of positions of the first plurality of feature points and a second plurality of positions of the second plurality of feature points, wherein each of the first plurality of feature points and the second plurality of feature points comprise one or more vertices and one or more facial keypoints; and
performing, according to the matching relationship and using the second plurality of positions as a plurality of reference positions, a position adjustment on a plurality of vertices forming the first source head model, to obtain the second source head model, and
wherein distances between a third plurality of positions of a third plurality of feature points in the second source head model and a plurality of corresponding reference positions are determined according to the matching relationship such that a proximity condition is satisfied.

3. The model processing method according to claim 1, wherein the determining the deformation parameter comprises:
determining, according to a second plurality of positions of a second plurality of feature points in the second source head model and a first plurality of positions of a first plurality of feature points in the first source head model corresponding to the second plurality of feature points, the first deformation relationship, wherein each of the first plurality of feature points and the second plurality of feature points comprises: one or more vertices and one or more facial keypoints; and
determining the deformation parameter according to the first deformation relationship and the second deformation relationship.

4. The model processing method according to claim 3, wherein the first deformation relationship comprises a transformation matrix from a plurality of vertices of a target triangle in the first source head model to a plurality of corresponding vertices in the second source head model, and wherein the transformation matrix is determined according to an affine transformation parameter and a translation parameter.

5. The model processing method according to claim 3, wherein the determining the deformation parameter comprises:
determining, according to the first deformation relationship, a first vertex deformation relationship between a plurality of reference vertices in the first source head model and a plurality of corresponding vertices in the second source head model;
determining, according to the second deformation relationship, a second vertex deformation relationship between the plurality of reference vertices in the first source head model as represented by the first model expression and the plurality of reference vertices in the first source head model as represented by the second model expression; and
determining, according to the first vertex deformation relationship and the second vertex deformation relationship, a plurality of vertex deformation parameters of a plurality of target vertices in the first target head model that correspond to the plurality of reference vertices in the first source head model.

6. The model processing method according to claim 1, wherein the performing the expression transfer comprises:
determining, in the first target head model, a plurality of feature regions forming the first target head model;
adjusting, according to a plurality of vertex deformation parameters of a plurality of vertices in a facial feature region in the first target head model, a plurality of positions of corresponding vertices in the first target head model having the first model expression, to obtain an adjusted target head model, wherein the facial feature region has a largest surface area in the plurality of feature regions; and
performing, based on an adjustment rule for a target feature region in the plurality of feature regions, expression adjustment on the target feature region based on the adjusted target head model, to obtain the second target head model having the second model expression.

7. The model processing method according to claim 6, wherein the performing the expression adjustment on the target feature region comprises:
determining, from the plurality of feature regions, a linked feature region corresponding to the target feature region; and
performing, based on an instruction of the adjustment rule, a follow-up adjustment on the target feature region according to an adjustment of a first plurality of positions of a first plurality of vertices in the linked feature region.

8. The model processing method according to claim 7, wherein the performing the follow-up adjustment comprises:
based on an overlapping area between the target feature region and the linked feature region being less than an area threshold, applying a rigid adjustment to a second plurality of positions of a second plurality of vertices in the target feature region, following the adjustment of the first plurality of positions; and
based on the overlapping area between the target feature region and the linked feature region being greater than or equal to the area threshold, applying a Laplace's adjustment to the second plurality of positions, following the adjustment of the first plurality of positions.

9. The model processing method according to claim 7, wherein the determining the linked feature region comprises:
determining, based on the target feature region belonging to an eyeball accessory region, a position relationship between the target feature region and an eyeball region in the plurality of feature regions; and
determining the linked feature region from the eyeball region and determining the facial feature region according to the position relationship,
wherein the eyeball region is determined as the linked feature region based on a distance between the target feature region and the eyeball region being less than a distance threshold, and
wherein the facial feature region is determined as the linked feature region based on the distance being greater than or equal to the distance threshold.

10. The model processing method according to claim 9, wherein the plurality of feature regions comprise the eyeball region, and wherein determining the eyeball region comprises:
determining a plurality of center points and a plurality of spherical similarities of the plurality of feature regions, wherein a spherical similarity indicates a degree to which a feature region resembles a sphere; and
determining the eyeball region from the plurality of feature regions according to:
a plurality of distances between the plurality of center points and a plurality of eyeball keypoints in a plurality of facial keypoints of the adjusted target head model, and
the plurality of spherical similarities.

11. A model processing apparatus, comprising:
at least one memory configured to store computer program code; and
at least one processor configured to read the program code and operate as instructed by the program code, the program code comprising:
obtaining code configured to cause at least one of the at least one processor to obtain a first source head model in response to an obtained expression movement instruction, the first source head model comprising neutral feature data, and a plurality of pieces of expression feature data relative to the neutral feature data;
deformation matching code configured to cause at least one of the at least one processor to perform deformation matching on the first source head model according to a first model feature of a first target head model, to obtain a second source head model subjected to deformation matching;
model expression code configured to cause at least one of the at least one processor to determine a deformation parameter according to a first deformation relationship between the first source head model and the second source head model and a second deformation relationship from a first model expression to a second model expression in the first source head model, the first model expression being determined according to the neutral feature data of the first source head model, and the second model expression being determined according to expression feature data indicated by the expression movement instruction in the plurality of pieces of expression feature data; and
expression transfer code configured to cause at least one of the at least one processor to perform expression transfer on the first target head model according to the deformation parameter, to obtain a second target head model having the second model expression.

12. The model processing apparatus according to claim 11, wherein the deformation matching code is configured to cause at least one of the at least one processor to:
determine a matching relationship between a first plurality of feature points in the first source head model and a second plurality of feature points in the first target head model according to a first plurality of positions of the first plurality of feature points and a second plurality of positions of the second plurality of feature points, wherein each of the first plurality of feature points and the second plurality of feature points comprise one or more vertices and one or more facial keypoints; and
perform, according to the matching relationship and using the second plurality of positions as a plurality of reference positions, a position adjustment on a plurality of vertices forming the first source head model, to obtain the second source head model, and
wherein distances between a third plurality of positions of a third plurality of feature points in the second source head model and a plurality of corresponding reference positions are determined according to the matching relationship such that a proximity condition is satisfied.

13. The model processing apparatus according to claim 11, wherein the model expression code is configured to cause at least one of the at least one processor to:
determine, according to a second plurality of positions of a second plurality of feature points in the second source head model and a first plurality of positions of a first plurality of feature points in the first source head model corresponding to the second plurality of feature points, the first deformation relationship, wherein each of the first plurality of feature points and the second plurality of feature points comprises: one or more vertices and one or more facial keypoints; and
determine the deformation parameter according to the first deformation relationship and the second deformation relationship.

14. The model processing apparatus according to claim 13, wherein the first deformation relationship comprises a transformation matrix from a plurality of vertices of a target triangle in the first source head model to a plurality of corresponding vertices in the second source head model, and wherein the transformation matrix is determined according to an affine transformation parameter and a translation parameter.

15. The model processing apparatus according to claim 13, wherein the model expression code is configured to cause at least one of the at least one processor to:
determine, according to the first deformation relationship, a first vertex deformation relationship between a plurality of reference vertices in the first source head model and a plurality of corresponding vertices in the second source head model;
determine, according to the second deformation relationship, a second vertex deformation relationship between the plurality of reference vertices in the first source head model as represented by the first model expression and the plurality of reference vertices in the first source head model as represented by the second model expression; and
determine, according to the first vertex deformation relationship and the second vertex deformation relationship, a plurality of vertex deformation parameters of a plurality of target vertices in the first target head model that correspond to the plurality of reference vertices in the first source head model.

16. The model processing apparatus according to claim 11, wherein the expression transfer code is configured to cause at least one of the at least one processor to:
determine, in the first target head model, a plurality of feature regions forming the first target head model;
adjust, according to a plurality of vertex deformation parameters of a plurality of vertices in a facial feature region in the first target head model, a plurality of positions of corresponding vertices in the first target head model having the first model expression, to obtain an adjusted target head model, wherein the facial feature region has a largest surface area in the plurality of feature regions; and
perform, based on an adjustment rule for a target feature region in the plurality of feature regions, expression adjustment on the target feature region based on the adjusted target head model, to obtain the second target head model having the second model expression.

17. The model processing apparatus according to claim 16, wherein the expression transfer code is configured to cause at least one of the at least one processor to:
determine, from the plurality of feature regions, a linked feature region corresponding to the target feature region; and
perform, based on an instruction of the adjustment rule, a follow-up adjustment on the target feature region according to an adjustment of a first plurality of positions of a first plurality of vertices in the linked feature region.

18. The model processing apparatus according to claim 17, wherein the expression transfer code is configured to cause at least one of the at least one processor to:
based on an overlapping area between the target feature region and the linked feature region being less than an area threshold, apply a rigid adjustment to a second plurality of positions of a second plurality of vertices in the target feature region, following the adjustment of the first plurality of positions; and
based on the overlapping area between the target feature region and the linked feature region being greater than or equal to the area threshold, apply a Laplace's adjustment to the second plurality of positions, following the adjustment of the first plurality of positions.

19. The model processing apparatus according to claim 17, wherein the expression transfer code is configured to cause at least one of the at least one processor to:
determine, based on the target feature region belonging to an eyeball accessory region, a position relationship between the target feature region and an eyeball region in the plurality of feature regions; and
determine the linked feature region from the eyeball region and determining the facial feature region according to the position relationship,
wherein the eyeball region is determined as the linked feature region based on a distance between the target feature region and the eyeball region being less than a distance threshold, and
wherein the facial feature region is determined as the linked feature region based on the distance being greater than or equal to the distance threshold.

20. A non-transitory computer-readable storage medium, storing computer code which, when executed by at least one processor, causes the at least one processor to at least:
obtain a first source head model in response to an obtained expression movement instruction, the first source head model comprising neutral feature data, and a plurality of pieces of expression feature data relative to the neutral feature data;
perform deformation matching on the first source head model according to a first model feature of a first target head model, to obtain a second source head model subjected to deformation matching;
determine a deformation parameter according to a first deformation relationship between the first source head model and the second source head model and a second deformation relationship from a first model expression to a second model expression in the first source head model, the first model expression being determined according to the neutral feature data of the first source head model, and the second model expression being determined according to expression feature data indicated by the expression movement instruction in the plurality of pieces of expression feature data; and
perform expression transfer on the first target head model according to the deformation parameter, to obtain a second target head model having the second model expression.
